(19) United States
(12) Patent Application Publication
(10) Pub. No.: US 2025/0386238 A1
(43) Pub. Date: Dec. 18, 2025

(54) ARTIFICIAL INTELLIGENCE-ENABLED ROUTING AND SPLITTING OF DATA TRAFFIC

(71) Applicant: QUALCOMM Incorporated, San Diego, CA (US)

(72) Inventors: Sherif ELAZZOUNI, San Diego, CA (US); Gavin Bernard HORN, La Jolla, CA (US); Ozcan OZTURK, San Diego, CA (US); Vishal DALMIYA, San Diego, CA (US); Vaishakh RAO, San Diego, CA (US)

(21) Appl. No.: 18/745,477

(22) Filed: Jun. 17, 2024

(51) Int. Cl. H04W 28/02; H04W 16/22

(52) U.S. Cl. CPC H04W 28/0247; H04W 16/22; H04W 28/0273

(57) ABSTRACT

Methods, systems, and devices for wireless communications are described. A first wireless device may select a value to use as a data volume threshold value for determinations of routing or splitting of data traffic across radio link control (RLC) entities. The selection by the first wireless device of the data volume threshold for data splitting by a protocol data convergence protocol (PDCP) layer may be based on an output of a learning model. In some examples, the first wireless device may be configured to override a data volume threshold value indicated by a network entity and transmit data over a secondary RLC entity regardless of data volume, or the first wireless device may be configured to disable a primary RLC path for a duration, among other embodiments.

### FIELD OF TECHNOLOGY

The following relates to wireless communications, including artificial intelligence (AI)-enabled routing and splitting of data traffic.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support artificial intelligence (AI)-enabled routing and splitting of data traffic.

A method for wireless communications by a wireless device is described. The method may include receiving control signaling that indicates a configuration including a first set of one or more parameters for one or more of splitting or routing a set of protocol data units (PDUs) by a protocol data convergence protocol (PDCP) entity of the wireless device to one or more of a first radio link control (RLC) entity or a second RLC entity of the wireless device, where at least one parameter of the first set of one or more parameters is associated with a set of multiple values, a set of multiple performance metrics, or a combination thereof, selecting a value of the set of multiple values for the at least one parameter, for one or more of splitting or routing the set of PDUs, based on a second set of one or more parameters, where the selected value corresponds to an uplink data volume threshold, and processing the set of PDUs, by one or more of splitting or routing one or more PDUs of the set of PDUs to one or more of the first RLC entity or the second RLC entity of the wireless device, based on an uplink data volume associated with one or more of the PDCP entity, the first RLC entity, or the second RLC entity and according to the selected value.

A wireless device for wireless communications is described. The wireless device may include one or more memories storing processor executable code, and one or more processors coupled with the one or more memories. The one or more processors may individually or collectively be operable to execute the code to cause the wireless device to receive control signaling that indicates a configuration including a first set of one or more parameters for one or more of splitting or routing a set of PDUs by a PDCP entity of the wireless device to one or more of a first RLC entity or a second RLC entity of the wireless device, where at least one parameter of the first set of one or more parameters is associated with a set of multiple values, a set of multiple performance metrics, or a combination thereof, select a value of the set of multiple values for the at least one parameter, for one or more of splitting or routing the set of PDUs, based on a second set of one or more parameters, where the selected value corresponds to an uplink data volume threshold, and process the set of PDUs, by one or more of splitting or routing one or more PDUs of the set of PDUs to one or more of the first RLC entity or the second RLC entity of the wireless device, based on an uplink data volume associated with one or more of the PDCP entity, the first RLC entity, or the second RLC entity and according to the selected value.

Another wireless device for wireless communications is described. The wireless device may include means for receiving control signaling that indicates a configuration including a first set of one or more parameters for one or more of splitting or routing a set of PDUs by a PDCP entity of the wireless device to one or more of a first RLC entity or a second RLC entity of the wireless device, where at least one parameter of the first set of one or more parameters is associated with a set of multiple values, a set of multiple performance metrics, or a combination thereof, means for selecting a value of the set of multiple values for the at least one parameter, for one or more of splitting or routing the set of PDUs, based on a second set of one or more parameters, where the selected value corresponds to an uplink data volume threshold, and means for processing the set of PDUs, by one or more of splitting or routing one or more PDUs of the set of PDUs to one or more of the first RLC entity or the second RLC entity of the wireless device, based on an uplink data volume associated with one or more of the PDCP entity, the first RLC entity, or the second RLC entity and according to the selected value.

A non-transitory computer-readable medium storing code for wireless communications is described. The code may include instructions executable by one or more processors to receive control signaling that indicates a configuration including a first set of one or more parameters for one or more of splitting or routing a set of PDUs by a PDCP entity of the wireless device to one or more of a first RLC entity or a second RLC entity of the wireless device, where at least one parameter of the first set of one or more parameters is associated with a set of multiple values, a set of multiple performance metrics, or a combination thereof, select a value of the set of multiple values for the at least one parameter, for one or more of splitting or routing the set of PDUs, based on a second set of one or more parameters, where the selected value for the at least one parameter, and process the set of PDUs, by one or more of splitting or routing one or more PDUs of the set of PDUs to one or more of the first RLC entity or the second RLC entity of the wireless device, based on an uplink data volume associated with one or more of the PDCP entity, the first RLC entity, or the second RLC entity and according to the selected value.

Some examples of the method, wireless devices, and non-transitory computer-readable medium described herein may further include operations, features, means, or instructions for obtaining the value from a learning model associated with the PDCP entity of the wireless device, where an input to the learning model includes one or more of the first set of one or more parameters or the second set of one or more parameters, where the value includes an output of the learning model, where the value may be selected based on the output of the learning model.

In some examples of the method, wireless devices, and non-transitory computer-readable medium described herein, the second set of one or more parameters includes one or more of at least one first parameter that indicates a first performance associated with a hybrid automatic repeat request (HARQ) process for one or more of the first RLC entity of the wireless device or the second RLC entity of the wireless device, or at least one second parameter that indicates a second performance associated with a RLC process for one or more of the first RLC entity of the wireless device or the second RLC entity of the wireless device.

Some examples of the method, wireless devices, and non-transitory computer-readable medium described herein may further include operations, features, means, or instructions for transmitting, to a second wireless device, a radio resource control (RRC) message including an indication of the selected value or transmitting, to the second wireless device, a medium access control-control element (MAC-CE) including the indication of the selected value, where the second wireless device include a UE or a network entity, wherein the network entity includes a base station or a server associated with a learning model.

Some examples of the method, wireless devices, and non-transitory computer-readable medium described herein may further include operations, features, means, or instructions for receiving, from the second wireless device, an indication of a second value of the set of multiple values for the at least one parameter, where processing the set of PDUs, by one or more of splitting or routing one or more PDUs of the set of PDUs to one or more of the first RLC entity or the second RLC entity of the wireless device, may be based on the uplink data volume associated with one or more of the PDCP entity, the first RLC entity, or the second RLC entity and according to the second value of the set of multiple values for the at least one parameter.

Some examples of the method, wireless devices, and non-transitory computer-readable medium described herein may further include operations, features, means, or instructions for generating at least one PDU including an indication of the selected value and outputting, to a second wireless device via the PDCP entity of the wireless device, the at least one PDU including the indication of the selected value, where the at least one PDU includes a PDCP data PDU or a PDCP control PDU, and where the second wireless device include a UE or a network entity, where the network entity includes a base station or a server associated with a learning model.

Some examples of the method, wireless devices, and non-transitory computer-readable medium described herein may further include operations, features, means, or instructions for receiving, from a second wireless device, an indication of at least one acknowledgment or negative acknowledgment associated with the selected value, where the second wireless device includes a UE or a network entity, where the network entity includes a base station or a server associated with a learning model.

Some examples of the method, wireless devices, and non-transitory computer-readable medium described herein may further include operations, features, means, or instructions for processing, based on the configuration and an availability of one or more resources in a grant associated with the second RLC entity, the set of PDUs, by one or more of splitting or routing the one or more PDUs of the set of PDUs to one or more of the first RLC entity or the second RLC entity of the wireless device irrespective of the uplink data volume threshold and the uplink data volume associated with the second RLC entity.

Some examples of the method, wireless devices, and non-transitory computer-readable medium described herein may further include operations, features, means, or instructions for determining whether to disable the first RLC entity or the second RLC entity of the wireless device for a duration according to a learning model associated with the PDCP entity of the wireless device, where an input to the learning model includes one or more of the first set of one or more parameters or the second set of one or more parameters and disabling the first RLC entity or the second RLC entity of the wireless device for the duration based on the determining, where an output of the learning model indicates to disable the first RLC entity or the second RLC entity of the wireless device.

Some examples of the method, wireless devices, and non-transitory computer-readable medium described herein may further include operations, features, means, or instructions for performing a PDU recovery procedure by routing at least one PDU of the set of PDUs from the first RLC entity to the second RLC entity of the wireless device based on disabling the first RLC entity of the wireless device.

Some examples of the method, wireless devices, and non-transitory computer-readable medium described herein may further include operations, features, means, or instructions for switching from the first RLC entity as a primary RLC path to the second RLC entity as the primary RLC path for the set of PDUs and switching from the second RLC entity as the primary RLC path to the first RLC entity as the primary RLC path for the set of PDUs.

In some examples of the method, wireless devices, and non-transitory computer-readable medium described herein, a third set of one or more parameters include an output of a learning model associated with the PDCP entity of the wireless device and the third set of one or more parameters may be based on a first channel quality indicator threshold value associated with the first RLC entity of the wireless device, a second channel quality indicator threshold value associated with the second RLC entity of the wireless device, or both.

Some examples of the method, wireless devices, and non-transitory computer-readable medium described herein may further include operations, features, means, or instructions for storing a set of one or more logs associated with a learning model, where at least one first log of the set of one or more logs includes a set of previous selected values of the set of multiple values for the at least one parameter, where at least one second log of the set of one or more logs includes a third set of one or more parameters associated with one or more of the first RLC entity or the second RLC entity of the wireless device, the third set of one or more parameters including one or more of a channel quality indicator or a reference signal received power, where at least one third log of the set of one or more logs includes a fourth set of one or more parameters associated one or more of the first RLC entity or the second RLC entity of the wireless device, the fourth set of one or more parameters including one or more of a channel quality indicator threshold value or a reference signal received power threshold value, where at least one fourth log of set of one or more logs includes a fifth set of one or more parameters including at least one parameter that indicates an end-to-end (E2E) delay associated with one or more of the first RLC entity or the second RLC entity of the wireless device, and where at least one fifth log of set of one or more logs includes an indication of one or more recovery procedures performed by the wireless device and associated with one or more of the first RLC entity or the second RLC entity of the wireless device and transmitting, to a second wireless device, a report including the set of one or more logs associated with the learning model.

Some examples of the method, wireless devices, and non-transitory computer-readable medium described herein may further include operations, features, means, or instructions for transmitting, to a second wireless device, a report including capability information that indicates whether the wireless device supports a learning model associated with one or more of splitting or routing the set of PDUs, where the capability information further indicates whether the wireless device supports one or more of predicting latency associated with one or more of the first RLC entity or the second RLC entity of the wireless device, or reporting of an accuracy of the learning model, where receiving the control signaling may be based on the capability information.

In some examples of the method, wireless devices, and non-transitory computer-readable medium described herein, the first set of one or more parameters includes one or more of at least one first parameter that indicates a first threshold value for the uplink data volume, at least one second parameter that indicates a second threshold value for the uplink data volume, at least one third parameter that indicates a threshold quantity of grants allowed to be missed at the wireless device for the first RLC entity of the wireless device, at least one fourth parameter that indicates whether the wireless device may be configured to disable at least one of the first RLC entity or the second RLC entity, at least one fifth parameter that indicates whether data recovery may be configured in response to at least one of the first RLC entity or the second RLC entity being disabled, at least one sixth parameter that indicates a first threshold duration for disabling at least one of the first RLC entity or the second RLC entity, at least one seventh parameter that indicates a second threshold duration to be satisfied prior to disabling at least one of the first RLC entity or the second RLC entity, at least one eighth parameter that indicates whether primary path switching may be allowed for at least one of the first RLC entity or the second RLC entity, at least one nineth parameter that indicates a channel quality indicator (CQI) threshold value to be satisfied prior to disabling at least one of the first RLC entity or the second RLC entity of the wireless device, at least one tenth parameter that indicates whether a learning model may be enabled or disabled, or at least one eleventh parameter that indicates whether the learning model may be enabled or disabled for a Quality-of-Service (QOS) flow associated with the set of PDUs.

In some examples of the method, wireless devices, and non-transitory computer-readable medium described herein, the second set of one or more parameters includes one or more of at least one first parameter that indicates a first criterion associated with an order of transmission or reception of the set of PDUs, at least one second parameter that indicates a second criterion associated with retransmission of one or more PDUs of the set of PDUs, at least one third parameter that indicates a third criterion associated with a latency of transmission, reception, or retransmission of one or more PDUs of the set of PDUs, or at least one fourth parameter that indicates a fourth criterion associated with a reordering window for one or more PDUs of the set of PDUs.

Some examples of the method, wireless devices, and non-transitory computer-readable medium described herein may further include operations, features, means, or instructions for receiving, from a second wireless device, a report that indicates a performance associated with one or more of the first set of one or more parameters or the second set of one or more parameters for one or more of splitting or routing the set of PDUs by the PDCP entity of the wireless device to one or more of the first RLC entity or the second RLC entity of the wireless device.

### BRIEF DESCRIPTION OF THE DRAWINGS

FIG. 1 shows an example of a wireless communications system that supports artificial intelligence (AI)-enabled routing and splitting of data traffic in accordance with one or more aspects of the present disclosure.

FIG. 2 shows an example of a machine learning (ML) architecture that supports AI-enabled routing and splitting of data traffic in accordance with one or more aspects of the present disclosure.

FIGS. 3 and 4 show examples of block diagrams of a user equipment (UE) that support AI-enabled routing and splitting of data traffic in accordance with one or more aspects of the present disclosure.

FIGS. 5 through 11 show examples of process flows that support AI-enabled routing and splitting of data traffic in accordance with one or more aspects of the present disclosure.

FIG. 12 shows an example of a wireless communications system that supports AI-enabled routing and splitting of data traffic in accordance with one or more aspects of the present disclosure.

FIG. 13 is an illustrative block diagram of an example ML architecture that may be used for wireless communications in accordance with one or more aspects of the present disclosure.

FIG. 14 shows an example of a process flow that supports AI-enabled routing and splitting of data traffic in accordance with one or more aspects of the present disclosure.

FIGS. 15 and 16 show block diagrams of devices that support AI-enabled routing and splitting of data traffic in accordance with one or more aspects of the present disclosure.

FIG. 17 shows a block diagram of a communications manager that supports AI-enabled routing and splitting of data traffic in accordance with one or more aspects of the present disclosure.

FIG. 18 shows a diagram of a system including a device that supports AI-enabled routing and splitting of data traffic in accordance with one or more aspects of the present disclosure.

FIG. 19 shows a flowchart illustrating methods that support AI-enabled routing and splitting of data traffic in accordance with one or more aspects of the present disclosure.

### DETAILED DESCRIPTION

A wireless device may be equipped with a protocol stack to support various functionalities associated with wireless communication. The protocol stack may include various protocol layers. One example of a protocol layer includes a radio link control (RLC) layer (also referred to as an RLC entity herein). The RLC layer may perform transfer of upper layer protocol data units (PDUs) according to one or more modes, including: an acknowledged mode (AM), an unacknowledged mode (UM), and a transparent mode (TM). The RLC layer may be referred to as a TM RLC entity, a UM RLC entity, or an AM RLC entity based on a configured mode of data transfer for the RLC entity. The RLC layer may receive an RLC data PDU from and/or transmit to upper protocol layers of the protocol stack of the wireless device. The RLC layer may be configured with a split bearer over two paths (e.g., two bidirectional UM RLC entities, four unidirectional UM RLC entities, two AM RLC entities). A packet data convergence protocol (PDCP) layer (also referred to as a PDCP entity herein) of the wireless device may determine whether to split PDUs over the two paths, and the determination to split may be based on a data volume at the PDCP layer or one or more RLC layers, or both satisfying a threshold value (e.g., ul-DataSplitThreshold). The term “data volume,” as used herein, may refer to a certain amount of data.

In some cases, a wireless device (e.g., a PDCP layer of the wireless device) may experience inefficiencies or latencies based on splitting PDUs across two paths. For example, a threshold value (e.g., ul-DataSplitThreshold) to enable splitting may be relatively high, which may prevent the PDCP layer from routing (e.g., forwarding) PDUs to a second RLC entity when a first RLC entity is experiencing degradation (e.g., poor radio link quality, a radio link failure (RLF)). Instead, the PDCP layer may be forced to route PDUs to the first RLC entity, and the PDUs at the first RLC entity may undergo extensive delays due to the degradation of the first RLC entity. That is, the PDCP layer may be inhibited from utilizing available resources at the second RLC entity to process PDUs (e.g., thereby clearing PDCP buffers) due to the threshold value for a data volume that enables the splitting of PDUs across RLC entities.

In accordance with examples described herein, the wireless device may select a different value to use as the threshold value (e.g., ul-DataSplitThreshold) for splitting of PDUs across RLC entities compared with the threshold value for splitting that is configured for the wireless device by a network entity (e.g., a base station). In some examples, the wireless device may be configured to override the threshold value (e.g., ul-DataSplitThreshold) configured by the network entity and transmit PDUs over the second RLC entity (e.g., forward PDUs from the PDCP layer to the second RLC entity) regardless of data volume, or the wireless device may be configured to disable the first RLC entity (e.g., a primary RLC entity) for routing PDUs for a duration, among other examples.

Various aspects of the present disclosure relate to enabling a wireless device (e.g., a PDCP layer of the wireless device) to support routing or splitting of RLC PDUs (e.g., selection of threshold values for the splitting) according to a learning model (e.g., an artificial intelligence (AI)/machine learning (ML) model). The learning model may improve efficient processing (e.g., splitting) of RLC data PDUs. In some examples, the learning model may enable the wireless device to support efficient monitoring of congestion levels and adjust parameters dynamically for processing (e.g., splitting) of RLC data PDUs. Additionally, the wireless device may be configured with one or more parameters and constraints for the learning model. In some examples, the wireless device may maintain and report logs for tracking a performance of the learning model, specifically related to splitting and routing of RLC data PDUs.

By enabling the wireless device to support routing and/or splitting of RLC data PDUs according to the learning model (e.g., an AI/ML model), the wireless device may mitigate unnecessary retransmissions of RLC data PDUs, may prevent reordering delays associated with RLC data PDUs, among other examples as described herein. It should be understood that other models or data structures (e.g., tables) may be used for supporting and enabling the wireless device (e.g., an RLC layer of the wireless device) to support processing (e.g., splitting, routing) of RLC data PDUs as described herein.

Aspects of the disclosure are initially described in the context of wireless communications systems. Aspects of the disclosure are further illustrated by and described with reference to apparatus diagrams, system diagrams, and flowcharts that relate to AI-enabled routing and splitting of data traffic.

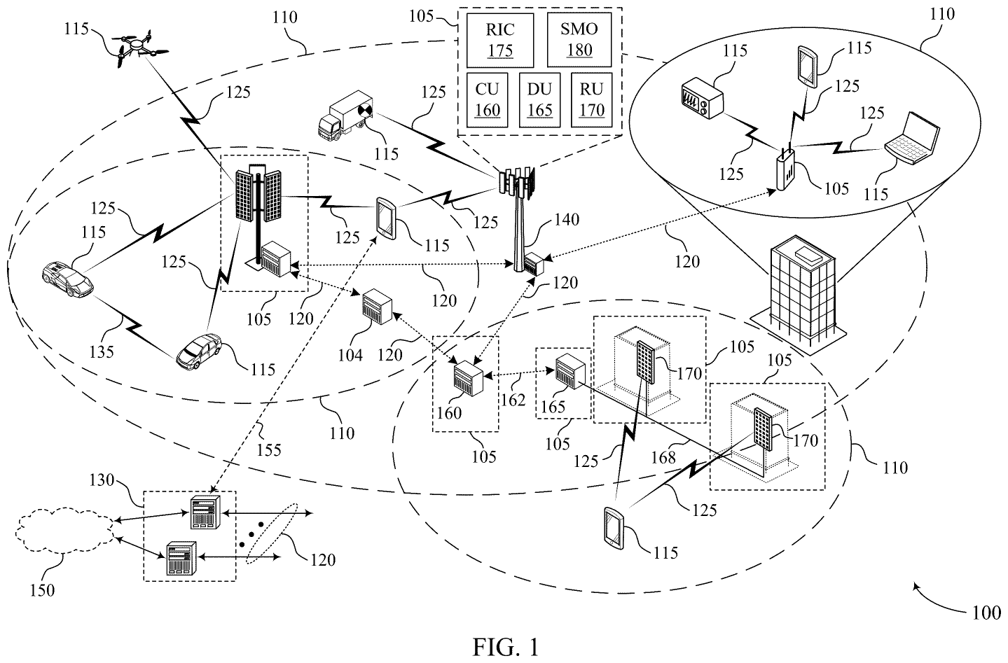

FIG. 1 shows an example of a wireless communications system 100 that supports AI-enabled routing and splitting of data traffic in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., RLC layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Certain aspects and techniques as described herein may be implemented, at least in part, using an artificial intelligence (AI) program, such as a program that includes a machine learning (ML) or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

In some aspects, an ML model may be configured to provide computing capabilities for wireless communications. Such an ML model may be configured with weights and biases to perform routing and splitting of data traffic (e.g., PDUs). Thus, during operation of a device (e.g., network entity 105, UE 115, and/or base station 140), the ML model may receive input data and make inferences based on the weights and biases.

ML models may be deployed in one or more devices (for example, network entities 105 and UEs 115) and may be configured to enhance various aspects of the wireless communication system 100. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values. For example, a classification ML model configured according to aspects of this disclosure may produce an output which includes a determination for routing and splitting of data traffic (e.g., PDUs). A regression ML model configured according to embodiments of this disclosure may produce an output which includes a determination for routing and splitting of data traffic (e.g., PDUs). Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback may be one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., ARQ). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, a UE 115 (e.g., a PDCP layer of the UE 115) may experience inefficiencies or latencies based on splitting PDUs across two paths (e.g., across two different RLC layers of the UE 115). For example, a threshold value (e.g., configured by a network entity 105) to enable splitting may be relatively high (e.g., above a threshold), which may prevent the PDCP layer of the UE 115 from routing (e.g., forwarding) PDUs to a second RLC layer when a first RLC layer is experiencing degradation (e.g., poor radio link quality, a radio link failure). Instead, the PDCP layer may be forced to route PDUs to the first RLC layer of the UE 115, and the PDUs at the first RLC layer of the UE 115 may undergo extensive delays due to a degradation, or relatively poor radio quality, or the like.

The PDCP layer of the UE 115 may be inhibited from utilizing available resources at the second RLC layer of the UE 115 for routing of PDUs and to clear PDCP buffers due to the threshold value for a data volume that enables the splitting of PDUs across RLC layers of the UE 115. Thus, in accordance with examples described herein, the UE 115 may select a different value to use as the threshold value for splitting of PDUs across RLC entities compared with the threshold value for splitting that is configured for the UE 115 by the network entity 105 or the base station 140. For example, the UE 115 may be configured to override an ul-DataSplitThreshold configured by the network entity 105 or the base station 140, and transmit PDUs over the second RLC layer of the UE 115 (e.g., forward PDUs from the PDCP layer of the UE 115 to the second RLC layer of the UE 115) regardless of data volume, or the UE 115 may be configured to disable the first RLC layer, for example, a primary RLC entity for routing PDUs, among other examples.

The description herein illustrates, by way of some examples, how one or more tasks or problems in wireless communications may benefit from the application of one or more ML models for routing and splitting of data traffic (e.g., PDUs). To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

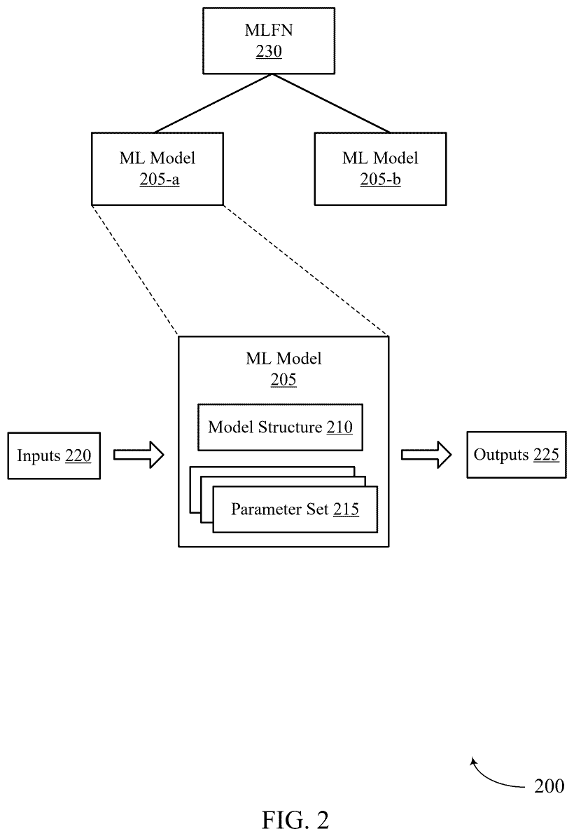

FIG. 2 shows an example of a ML architecture 200 that supports AI-enabled routing and splitting of data traffic in accordance with one or more aspects of the present disclosure. The ML architecture 200 illustrates an implementation for a ML model 205 (e.g., an AI model), which may be used to perform one or more of the features described herein. The ML model 205 may generate a set of one or more outputs 225 based on a set of one or more inputs 220. For example, the ML model 205 may be a data driven model (e.g., algorithm), which uses learning techniques (e.g., AI techniques) to generate the outputs 225. In some cases, the ML model 205 may be described using a model structure 210. For example, the ML model 205 may include one or more computation graphs, and the model structure 210 may define a structure for the ML model 205 for generating the outputs 225.

The ML model 205 may include one or more parameter sets 215. The parameter sets 215 may be neural network weights, for example, which may be used in combination with the model structure 210 to generate the outputs 225. In some examples, the ML model 205 (e.g., alone or in combination with other ML models 205) may implement a ML function (e.g., an AI function) which may generate the outputs 225 based on the inputs 220.

In some examples, a ML feature name (MLFN) 230 may be used to identify a function performed by the ML model 205. For example, the MLFN 230 may correspond to CSI feedback, beam management, positioning, or other functionalities. In some cases, the ML model 205 may be identified using a model ID. For example, the MLFN 230 may be associated with a model ID corresponding to the ML model 205. Each model ID may correspond to (e.g., identify) a ML model 205 (e.g., a ML model 205-a and a ML model 205-b) having a defined model structure 210, one or more parameter sets 215, or a combination thereof, as described herein. Additionally, or alternatively, the MLFN 230 may identify the ML model 205 using a model structure ID (e.g., MS ID), parameter set ID (e.g., PS IDs), or both. For example, the MLFN 230 may be associated with one or more model structure IDs, and each structure ID may identify a model structure 210 of a ML model 205. The MLFN 230 (e.g., or each structure ID) may also be associated with one or more parameter set IDs, each parameter set ID identifying a corresponding parameter set 215 for use with the corresponding model structure 210.

As such, model information may include MLFNs 230, model IDs, a model structure IDs, parameter set IDs, or a combination thereof. In some examples, each model ID may be associated with a model structure 210 and one or more parameter sets 215, and may be represented by a string. For instance, the string may correspond to a flat namespace, such as a single value that represents a tuple that includes the model structure 210 and the one or more parameter sets 215. Alternatively, the string may be a hierarchical namespace, such as the tuple including the model structure 210 and the one or more parameter sets 215.

In some cases, each model ID may be unique with respect to an MLFN 230. For example, each model ID may identify a separate ML model 205 (e.g., for a vendor), and may be unique such that each model ID refers to a single corresponding ML model 205. Similarly, each model structure ID may also be unique with respect to a MLFN 230. In some cases, each model ID, model structure ID, or both, may be specific to a public land mobile network (PLMN). Additionally, or alternatively, the model IDs and model structure IDs may be standardized or may administered separately (e.g., per vendor) without standardizing.

A network entity 105 or a base station 140 may configure and manage use of the ML model 205 for a UE 115. In some examples, the network entity 105 or the base station 140 may manage ML at the UE 115 at a feature level, for example, by configuring the UE 115 by indicating a MLFN 230. Additionally, or alternatively, the network entity 105 or the base station 140 may manage ML models 205 within each feature, and may configure the UE 115 using specific model IDs (e.g., indicating a model structure 210 and one or more parameter sets 215) corresponding to each feature. In some examples, the network entity 105 or the base station 140 may manage the parameter sets of each ML model 205, and the network entity 105 or the base station 140 may configure the UE 115 by indicating a model structure ID corresponding to a model structure 210 and one or more parameter sets 215. The parameter sets 215 may be explicitly indicated by the network entity 105 or the base station 140 to the UE 115, which may allow for more flexibility of the parameters, and may reduce the storage requirements at the UE 115 for storing parameter sets 215. Alternatively, the network entity 105 or the base station 140 may indicate the parameter sets 215 using one or more parameter IDs, which may reduce communication overhead between the UE 115 and the network entity 105 or the base station 140.

In some examples, ML models 205 may be one-sided models, which may be performed entirely at a UE 115 or the network (e.g., at one or more network entities 105 or base stations 140), or two-sided models, which may be performed at both the UE 115 and the network (e.g., the network entity 105 and/or the base station 140). One-sided models may be UE-side ML models 205, in which inference (e.g., running of the ML models 205) is performed at the UE 115. For example, the UE-side ML models 205 may involve non-UE specific inputs 220 (e.g., common to multiple UEs 115) and UE-specific inputs 220 (e.g., control inputs 220). In some cases, the UE 115 may receive control signaling or additional inputs 220 for the ML models 205 from a network entity 105 or a base station 140, while the ML model 205 inference is performed entirely at the UE 115. Inference for network-side ML models 205 may be performed at the network (e.g., at one or more network entities 105 or base stations 140), and the network may receive inputs 220 from the UE 115 to enter into the ML models 205. In some examples, the network may indicate the outputs 225 to the UE 115.

In two-sided ML models 205, joint inference may be performed. For example, one part of inference may be performed by the UE 115, and a remaining portion of the inference may be performed by one or more network entities 105 or base stations 140. For example, the UE 115 may perform a first portion of the inference for a ML model 205, and the network may perform a second part of the inference (e.g., based on data received from the UE 115, for example). Alternatively, the network may perform the first portion of the inference for a ML model 205, and the UE 115 may perform the second part of the inference (e.g., based on data received from the network entity 105 or the base station 140). To perform inference for the two-sided ML model 205, a network entity 105 or a base station 140 may signal one or more inputs 220 or other control signaling to the UE 115. Additionally, or alternatively, the UE 115 may transmit signaling indicating one or more inputs 220 or other control signaling to the network.

Accordingly, ML models 205 may be performed at a UE 115 or at one or more network entities 105 or base stations 140, as managed by the network, to perform different functions that may improve the operations and efficiency of the UE 115 and the network as described herein.

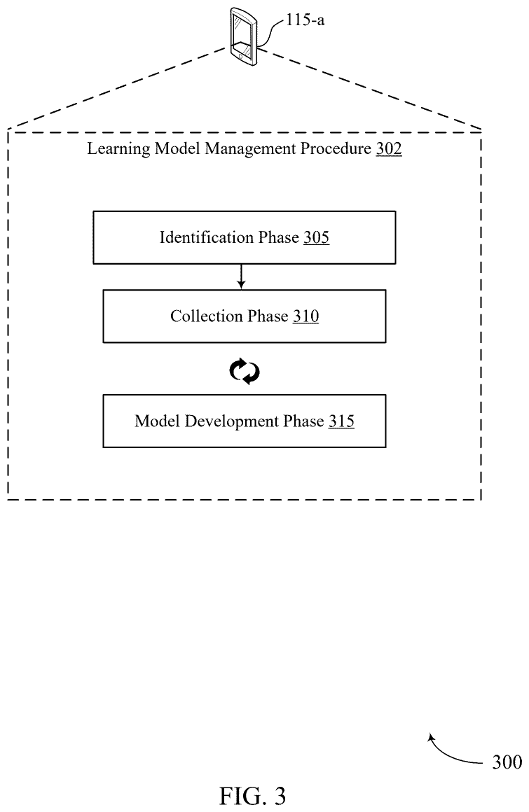

FIG. 3 shows an example of a block diagram 300 of a UE 115-a that supports AI-enabled routing and splitting of data traffic in accordance with one or more aspects of the present disclosure. The UE 115-a may be an example of aspects of a UE 115 as described herein with reference to FIGS. 1 and 2, respectively. The UE 115-a may implement aspects of the wireless communications system 100 as described with reference to FIG. 1.

In the example of FIG. 3, the UE 115-a may support a learning model management procedure 302 associated with one or more ML models for routing and splitting of data traffic, as described herein. The learning model management procedure 302 may include one or more of an identification phase 305, a collection phase 310 (also referred to as a data collection phase), and a model development phase 315.

One or more operations of the learning model management procedure 302 may be implemented by the UE 115-a or components (e.g., one or more memories storing processor-executable code, one or more processors coupled with the one or more memories and individually or collectively operable to execute the code to cause the UE 115-a to perform the operations) as described herein. In the following description of the learning model management procedure 302, the one or more operations performed by the UE 115-a may be performed in different orders or at different times. Some operations may also be omitted from the learning model management procedure 302, and other operations may be added to the learning model management procedure 302.

During the identification phase 305, the UE 115-a may identify an opportunity of applying a learning model. For example, the UE 115-a may identify a ML feature (MLF) for development at the UE 115-a. The UE 115-a may determine a use case for the learning model. In some examples, the UE 115-a may determine a task (e.g., an action) associated with the learning model, may determine inputs and outputs of the learning model, or both.

During the collection phase 310, the UE 115-a may collect data. For example, the UE 115-a may collect data based on actions or measurements that the UE 115-a performs, or the UE 115-a may collect data from multiple network elements (e.g., UEs, network entities, base stations). The data collected may be used as an input to the learning model for model development.

During the model development phase 315, the UE 115-a may process the data (e.g., before inputting the data to the learning model, as part of inputting the data to the learning model). To process the data, the UE 115-a may utilize one or more data filters, one or more selection criteria, or other data preparation parameters or procedures. The UE 115-a may design the model. A design of the learning model may be based on the MLF, the data available to the UE 115-a, one or more target outputs of the learning model, or a combination thereof. The UE 115-a may train the learning model (e.g., using the input data), and the UE 115-a may perform validation and testing of the learning model. For example, the UE 115-a may determine an accuracy or a reliability of the learning model and may calculate one or more accuracy metrics of the learning model. In some examples, the UE 115-a may continue to collect data for the learning model until the learning model has reached a threshold accuracy or reliability.

In some examples, multiple models may be developed for a same MLF (e.g., a same use case). The different models may be applicable to difference deployment environments, scenarios, or regions (e.g., geographical regions). In some examples, learning models may be universal models and may be generalized models that are applicable across deployments (e.g., all deployments). Universal models may be device specific or hardware specific. Some learning models may be regional models which may be deployment specific or network specific. Regional models may be applicable to some deployments, networks, and/or regions, but not others. Some learning models may be local models which may be applicable to a specific cell or to a local geographical area.

The UE 115-a may be capable of out-of-band or on-demand download of learning models. For example, because some models may be regional models or local models, the UE 115-a may download such learning models once the UE 115-a is in the field (e.g., on-demand downloading). In some examples, on-demand downloading of learning models at the UE 115-a may enable the UE 115-a to perform firmware over-the-air (FOTA) updates of existing models (e.g., downloaded models, such as out-of-band downloaded models), which may support federated learning of learning models.

Additionally, or alternatively, the learning model management procedure 302 may include a deployment of one or more learning models. For example, the UE 115-a may perform delivery or reception of a learning model (e.g., via an over the air interface or other signaling). That is, the UE 115-a may transmit an indication of the learning model to a network entity 105 or a base station 140 or may receive an indication of the learning model from a network entity 105 or a base station 140. In some examples, the indication of the learning model may indicate a partial model or a full model. A structure of the learning model may be known at a device receiving the learning model and the indication may include parameters for the model, or the indication may include a model (e.g., a model structure unknow by the UE 115-a) and parameters for the model.

The indication of the learning model may include a model executable. The model executable may be adjusted for different hardware platforms based on capabilities of the hardware platform and/or performance tradeoffs. The model executable may be downloaded directly to the UE 115-a or may be retrieved by the UE 115-a from a model repository (e.g., a database). In some cases, due to a memory restriction at the UE 115-a, the learning model may be downloaded by the UE 115-a during runtime. Additionally, or alternatively, the indication of the learning model may include one or more model management protocols. The model management protocols may include network and/or UE protocol functions to run the model. Additionally, or alternatively, the model management protocols may include layer 1 (L1)/layer 2 (L2) or RRC function handling (e.g., CSI type III support, MAC-control elements (MAC-CEs), RRC signaling for channel state feedback (CSF) configuration. In some cases, the model management protocols may include updated UE capabilities handling information (e.g., UE radio capability for CSF and supported CSF models).

The UE 115-a may retrieve the learning model from one or more model repositories. The model repository may store the model to download (e.g., transfer) to the UE 115-a. In some examples, the model repository may be a server (e.g., mobile network operator (MNO)). A model and parameter set configuration (e.g., indicating a set of learning models to be downloaded to the UE 115-a) may be configurable (e.g., dynamic), or may be static. Downloading the learning model to the UE 115-a may be in accordance with a model download format. The model download format may be a binary executable file or image or may be a model descriptor or label (e.g., in accordance with an open neural network exchange (ONNX)). In some examples, model quantization and/or compilation may be during an out-of-band period or may be during a runtime period of the UE 115-a.

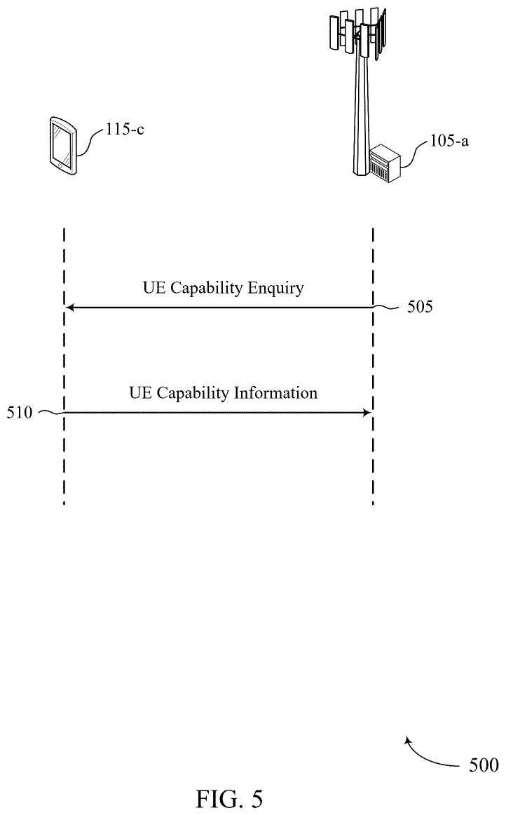

A learning model may undergo a life cycle, where the learning model progresses from one step of the life cycle to another. Steps of the model life cycle may include model development, model deployment, and model execution. For example, after development of a learning model, the learning model may be deployed. Based on model deployment, the UE 115-a may collect feedback of the learning model and may perform additional model development of the learning model (e.g., to improve or iterate on the learning model) based on the feedback. After model deployment, the learning model may be configured (e.g., for a particular use case, scenario), and the learning model may be executed by the UE 115-a (e.g., as described in greater detail with reference to FIG. 5). Based on model execution, the UE 115-a may collect feedback, may collect additional data, or both. The UE 115-a may perform model development of the learning model to improve the learning model based on the feedback and the additional data collected.

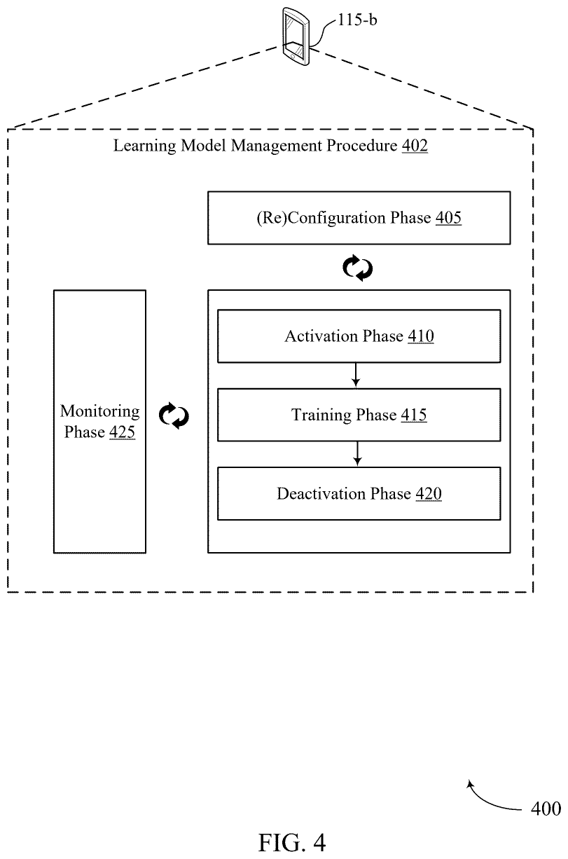

FIG. 4 shows a block diagram 400 of a UE 115-b that supports AI-enabled routing and splitting of data traffic in accordance with one or more aspects of the present disclosure. The UE 115-b may be an example of aspects of a UE 115 as described herein with reference to FIGS. 1 and 2, respectively. The UE 115-b may implement aspects of the wireless communications system 100 as described with reference to FIG. 1.

In the example of FIG. 4, the UE 115-b may support a learning model management procedure 402 associated with one or more ML models for routing and splitting of data traffic. The learning model management procedure 402 may include one or more of a (re) configuration phase 405, an activation phase 410, a training phase 415 (also referred to as an inference phase), a deactivation phase 420, or a monitoring phase 425. The one or more learning models may be locally stored (e.g., one or more memories storing processor-executable code) at the UE 115-b. Alternatively, the UE 115-b may obtain (e.g., download) the one or more learning models, for example, via a network entity 105 or a base station 140, as described herein with reference to FIGS. 1 and 2.

One or more operations of the learning model management procedure 402 may be implemented by the UE 115-b or components (e.g., one or more memories storing processor-executable code, one or more processors coupled with the one or more memories and individually or collectively operable to execute the code to cause the UE 115-b to perform the operations) as described herein. In the following description of the learning model management procedure 402, the one or more operations performed by the UE 115-b may be performed in different orders or at different times. Some operations may also be omitted from the learning model management procedure 402, and other operations may be added to the learning model management procedure 402.

During the (re) configuration phase 405, the UE 115-b may receive, from a network entity 105 or a base station 140, a set of one or more configurations including a set of one or more parameters for configuring or reconfiguring one or more learning models (e.g., AI models, ML models). The UE 115-b may receive, from a network entity 105 or a base station 140, a request message for configuring or reconfiguring the one or more learning models. The request may include the set of one or more configurations and one or more identifiers associated with one or more learning models. The UE 115-b may transmit, to the network entity 105 or the base station 140, a response message that includes an acknowledgement of the request message.

In some examples, the set of one or more parameters may be for managing (e.g., training, updating, modifying) the one or more learning models. In some other examples, the set of one or more parameters may be an input for the one or more learning models, for example, for inference of the one or more learning models. In other examples, the set of one or more parameters may be for monitoring one or more performance metrics (also referred to as key performance indicators (KPIs)) for the one or more learning models. Additionally, or alternatively, the set of one or more configurations may include one or more RRC configurations (e.g., one or more measurement configurations, one or more MAC configurations, or the like).

During the activation phase 410, the UE 115-b may activate at least one learning model (e.g., for at least one action). During the training phase 415, the UE 115-b may train the at least one learning model to obtain a set of one or more outputs based at least in part on a set of one or more inputs (e.g., a set of one or more parameters). During the deactivation phase 420, the UE 115-b may deactivate the at least one learning model (e.g., for at least one action).

During the monitoring phase 425, the UE 115-b may monitor (e.g., track) a performance of the at least one learning model. One or more of a network entity 105, a base station 140, or the UE 115-b may share (e.g., transmit, receive, exchange) feedback associated with the performance of the at least one learning model. The performance may be associated with a system performance (e.g., spectral efficiency, power consumption, delay, etc.) or a model performance (e.g., prediction accuracy, resource usage, inference delay, etc.). In some examples, one or more of a network entity 105, a base station 140, or the UE 115-b may trigger a switching event that includes switching (e.g., changing) from at least one learning model to at least one different learning model, for example, based at least in part on feedback associated with a performance of the at least one learning model. In some other examples, one or more of a network entity 105, a base station 140, or the UE 115-b may update the training of the at least one learning model based at least in part on the feedback associated with the performance of the at least one learning model.

The UE 115-b may switch from at least one learning model to at least one different learning model based at least in part on a function supported by the different learning model. In some examples, the UE 115-b may receive, from a network entity 105 or a base station 140, a request message to switch to the at least one different learning model. The request message may indicate an identifier associated with the at least one different learning model, and the UE 115-b may identify the least one different learning model based at least in part on the identifier. During the activation phase 410 of the learning model management procedure 402, the UE 115-b may activate the at least one different learning model (e.g., a different AI/ML model). Additionally, during the deactivation phase 420, the UE 115-b may deactivate the at least one learning model (e.g., a current AI/ML model).

Additionally, or alternatively, during the monitoring phase 425, the UE 115-b may trigger the switching event based at least in part on a change in one or more parameters of the UE 115-b (e.g., a number of antennas, a number of carriers, etc.). In some examples, the UE 115-b may trigger the switching event based at least in part on a change in a location of the UE 115-b (e.g., a change from an indoor environment to an outdoor environment, or vice-versa). In some other examples, the UE 115-b may trigger the switching event based at least in part on a change in a service (e.g., network slice, QOS flow, session, etc.).

Accordingly, the UE 115-b may be configured to support managing (e.g., configuring, reconfiguring, activating, deactivating, monitoring, reporting, etc.) of one or more leaning models.

FIG. 5 shows an example of a process flow 500 that supports AI-enabled routing and splitting of data traffic in accordance with one or more aspects of the present disclosure. The process flow 500 may implement aspects of the wireless communications system 100 as described with reference to FIG. 1. The process flow 500 may include a UE 115-c and a network entity 105-a, which may be examples of UEs 115 and network entities 105 as described herein. In the following description of the process flow 500, the operations between the UE 115-c and the network entity 105-a may be transmitted in a different order than the example order shown, or the operations performed by the UE 115-c and the network entity 105-a may be performed in different orders or at different times. Some operations may also be omitted from the process flow 500, and other operations may be added to the process flow 500.

In the example of FIG. 5, the UE 115-c may support providing an indication to the network entity 105-a of one or more learning models, including one or more features for routing and splitting of data traffic, supported by the UE 115-c. At 505, the network entity 105-a may transmit, and the UE 115-c may receive, a request message (e.g., a UE capability enquiry). The UE 115-c may determine, in response to the UE capability enquiry, a set of one or more UE capabilities. For example, the UE 115-c may determine whether the UE 115-c supports AI/ML functionality, including one or more learning models (e.g., AI/ML models) or one or more features associated with the one or more learning models for AI-enabled routing and splitting of data traffic.

At 510, the UE 115-c may transmit, and the network entity 105-a may receive, a response messages (e.g., UE capability information), in response to the request message. The UE capability information may include a set of one or more features supported by the UE 115-c. In some examples, the UE capability information may include a set of one or more identifiers associated with the one or more learning models, supported by the UE 115-c. Additionally, or alternatively, the UE capability information may include at least one field (e.g., information element (IE), flag, or the like) that indicates whether a corresponding learning model is loaded (e.g., initialized, stored, cached, or the like) at the UE 115-c. Additionally, or alternatively, the UE capability information may include a set of one or more identifiers associated with one or more learning model structures, or a set of one or more parameters for one or more features associated with the one or more learning model structures.

Accordingly, the UE 115-c may be configured to support exchange of UE capability information associated with one or more learning models for AI-enabled routing and splitting of data traffic.

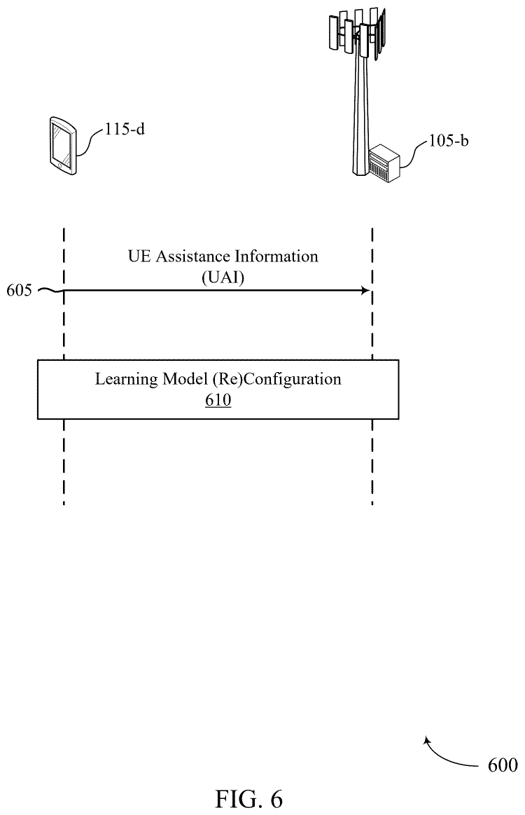

FIG. 6 shows an example of a process flow 600 that supports AI-enabled routing and splitting of data traffic in accordance with one or more aspects of the present disclosure. The process flow 600 may implement aspects of the wireless communications system 100 as described with reference to FIG. 1. The process flow 600 may include a UE 115-d and a network entity 105-b, which may be examples of UEs 115 and network entities 105 as described herein. In the following description of the process flow 600, the operations between the UE 115-d and the network entity 105-b may be transmitted in a different order than the example order shown, or the operations performed by the UE 115-d and the network entity 105-b may be performed in different orders or at different times. Some operations may also be omitted from the process flow 600, and other operations may be added to the process flow 600.

In the example of FIG. 6, the UE 115-d may support providing UE assistance information (UAI) to the network entity 105-b. More specifically, the UE 115-d may support transmitting, to the network entity 105-b, UAI for managing one or more learning models for AI-enabled routing and splitting of data traffic. At 605, the UE 115-d may transmit, and the network entity 105-b may receive, UAI that may indicate one or more restrictions (also referred to as restricted UE capabilities) associated with the one or more learning models for AI-enabled routing and splitting of data traffic. For example, the restricted UE capabilities may include a set of one or more learning models, a set of one or more identifiers associated with the set of one or more learning models, or both. In some examples, the restricted UE capabilities may exclude the set of one or more identifiers. In some examples, the UE 115-d may indicate a request to adjust (e.g., reduce, decrease, increase) a concurrency of the one or more learning models. For example, the UE 115-d may indicate a threshold number of concurrency (e.g., “maxAImachine learningconcurrency-Preference”) associated with the one or more learning models.

The UE 115-d may generate and transmit the UAI to the network entity 105-b based at least in part on a condition (e.g., an event). One or more examples of a condition may include, but is not limited to, a battery level of the UE 115-d satisfying a battery level threshold, a processor usage level of one or more processors of the UE 115-d satisfying a processor usage level threshold, or a heat level of one or more processors of the UE 115-d satisfying a heat level threshold. For example, the UE 115-d may transmit the UAI to the network entity 105-b to manage (e.g., deactivate, activate) one or more learning models for AI-enabled routing and splitting of data traffic at the UE 115-d based at least in part on one or more of the battery level of the UE 115-d satisfying the battery level threshold, the processor usage level of the one or more processors of the UE 115-d satisfying the processor usage level threshold, or the heat level of the one or more processors of the UE 115-d satisfying the heat level threshold.

Additionally, or alternatively, in some examples, the UAI may include a request for a set of one or more configurations associated with one or more learning models for AI-enabled routing and splitting of data traffic. In some examples, the UE 115-d may request the network entity 105-b for the set of one or more configurations associated with the one or more learning models based at least in part on a change in an environment of the UE 115-d. In some other examples, the UE 115-d may request the network entity 105-b for the set of one or more configurations associated with the one or more learning models based at least in part on a change in a state of the UE 115-d (e.g., a change between one or more of an idle state, an inactive state, or a connected state).

In other examples, the UE 115-d may request the network entity 105-b for the set of one or more configurations associated with the one or more learning models for AI-enabled routing and splitting of data traffic based at least in part on a session establishment associated with a network slice. For example, the UE 115-d may establish a session (e.g., a PDU session) associated with the network slice, and request the network entity 105-b for the set of one or more configurations associated with the one or more learning models for AI-enabled routing and splitting of data traffic. In some other examples, the UE 115-d may request the network entity 105-b for the set of one or more configurations associated with the one or more learning models for AI-enabled routing and splitting of data traffic based at least in part on a change in a geographic coverage area of the UE 115-d. For example, the UE 115-d may enter a new geographic coverage area of a cell, PLMN, and request the network entity 105-b for the set of one or more configurations associated with the one or more learning models for AI-enabled routing and splitting of data traffic.

At least one configuration of the set of one or more configurations associated with provisioning of network data as input for one or more learning models (e.g., AI/ML models). In some examples, the at least one configuration may indicate at least one identifier associated with at least one learning model supporting the network data as input to the least one learning model. In some examples, the UE 115-d may request (e.g., on-demand) for the network data from the network entity 105-b via the UAI, for example, based at least in part on the set of one or more configurations associated with provisioning of network data as input for one or more learning models (e.g., AI/ML models).

At 610, one or more of the UE 115-d or the network entity 105-b may configure or reconfigure at least one learning model for AI-enabled routing and splitting of data traffic. For example, the network entity 105-b may select at least one learning model to deactivate at the UE 115-d, based at least in part on the UAI, and transmit control signaling (e.g., RRC, MAC-CE, DCI) for deactivating the at least one learning model. For example, the network entity 105-b may determine and select which learning model to deactivate at the UE 115-d based at least in part on the UAI, and transmit the control signaling (e.g., RRC, MAC-CE, DCI) that indicates for the UE 115-d to deactivate the at least one learning model for AI-enabled routing and splitting of data traffic. Additionally, or alternatively, the network entity 105-b may determine and select which learning model to configure or reconfigure and activate at the UE 115-d based at least in part on the UAI. For example, the network entity 105-b may determine and select which learning model to activate at the UE 115-d based at least in part on the UAI, and transmit control signaling (e.g., RRC, MAC-CE, DCI) that indicates for the UE 115-d to activate the at least one learning model for AI-enabled routing and splitting of data traffic.

Accordingly, the UE 115-d may be configured to support exchange of UAI for managing for AI-enabled routing and splitting of data traffic.

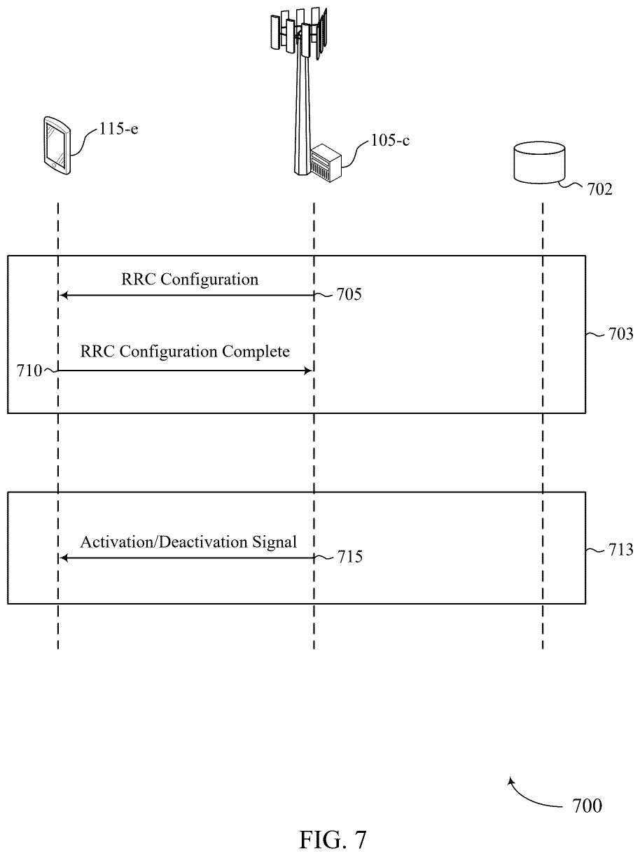

FIG. 7 shows an example of a process flow 700 that supports AI-enabled routing and splitting of data traffic in accordance with one or more aspects of the present disclosure. The process flow 700 may implement aspects of the wireless communications system 100 as described with reference to FIG. 1. The process flow 700 may include a UE 115-e and a network entity 105-c, which may be examples of UEs 115 and network entities 105 as described herein. Additionally, the process flow 700 may include a repository 702 (e.g., a database) storing one or more learning models for AI-enabled routing and splitting of data traffic. In the following description of the process flow 700, the operations between the UE 115-e, the network entity 105-c, and the repository 702 may be transmitted in a different order than the example order shown, or the operations performed by the UE 115-e, the network entity 105-c, and the repository 702 may be performed in different orders or at different times. Some operations may also be omitted from the process flow 700, and other operations may be added to the process flow 700.

In the example of FIG. 7, one or more of the UE 115-e or the network entity 105-c may support performing a procedure 703 (e.g., a model configuration procedure), which may include an exchange of a set of one or more configurations (or a set of one or more parameters) associated with one or more learning models for AI-enabled routing and splitting of data traffic. The set of one or more configurations (or the set of one or more parameters) associated with the one or more learning models for AI-enabled routing and splitting of data traffic may be stored at the repository 702 (e.g., a database, or the like), which the network entity 105-c may obtain from the repository 702.

At 705, the network entity 105-c may transmit, and the UE 115-e may receive, an RRC configuration message, which may include one or more sets of one or more configurations (or one or more sets of one or more parameters) associated with one or more learning models for AI-enabled routing and splitting of data traffic. The network entity 105-c may transmit, and the UE 115-e may receive, the RRC configuration message during the procedure 703, which may be an RRC configuration procedure. In some examples, the UE 115-e may configure one or more learning models via a layer 3 (L3) of the UE 115-e and based at least in part on the one or more sets of one or more configurations (or the one or more sets of one or more parameters) received in the RRC configuration message. At 710, the UE 115-e may transmit, and the network entity 105-c may receive, an RRC configuration complete message, for example, based at least in part on the RRC configuration message. The RRC configuration complete message may indicate a completion of the procedure 703 (e.g., the RRC configuration procedure), including configuring of the one or more learning models for AI-enabled routing and splitting of data traffic.

In the example of FIG. 6, additionally, or alternatively, at least one configuration of the sets of one or more configurations may be for provisioning network data by the network entity 105-c to the UE 115-e for input to one or more learning models (e.g., AI/ML models). In some examples, the at least one configuration may indicate at least one identifier associated with at least one learning model supporting the network data as input to the least one learning model. In some examples, the UE 115-e may request the network entity 105-c to activate or deactivate provisioning of network data as input to the at least one learning model via a MAC-CE. In some examples, the UE 115-e may receive, and the network entity 105-c may transmit, the network data via a unicast transmission and over a physical downlink channel (e.g., a physical downlink control channel (PDCCH), a physical downlink shared channel (PDSCH)). In some other examples, the UE 115-e may receive, and the network entity 105-c may transmit, the network data via a MAC-CE or an RRC message. In other examples, the UE 115-e may receive, and the network entity 105-c may transmit (e.g., broadcast), the network data via system information or a multicast broadcast service (MBS) transmission.

Additionally, or alternatively, at least one configuration of the sets of one or more configurations may be for provisioning, to the network entity 105-c, UE data as input for one or more learning models (e.g., AI/ML models). In some examples, the at least one configuration may indicate at least one identifier associated with at least one learning model supporting the UE data as input to the least one learning model. The network entity 105-c may request, from the UE 115-e, to activate or deactivate provisioning of UE data as input to the at least one learning model via a MAC-CE. In some examples, the UE 115-e may transmit, and the network entity 105-c may receive, UE data via a unicast transmission and over a physical uplink channel (e.g., a physical uplink control channel (PUCCH), a physical uplink shared channel (PUSCH)). In some other examples, the UE 115-e may transmit, and the network entity 105-c may receive, the UE data via a MAC-CE or an RRC message.

At 715, the network entity 105-c may transmit, and the UE 115-e may receive, a signal (also referred to as an activation signal or a deactivation signal) for activating or deactivating one or more learning models for AI-enabled routing and splitting of data traffic during a procedure 713 (e.g., an activation/deactivation procedure of one or more learning models for AI-enabled routing and splitting of data traffic). In some examples, the network entity 105-c may transmit, and the UE 115-e may receive via a layer 2 (L2) of the UE 115-e, the signal for activating or deactivating the one or more learning models for AI-enabled routing and splitting of data traffic. For example, the network entity 105-c may transmit, and the UE 115-e may receive, a MAC-CE that activates or deactivates the one or more learning models for AI-enabled routing and splitting of data traffic. In some examples, activating or deactivating the one or more learning models for AI-enabled routing and splitting of data traffic may be based at least in part on a switching event as described herein with reference to FIGS. 3 through 5.

Accordingly, one or more of the UE 115-e or the network entity 105-c may be configured to support managing ML models for AI-enabled routing and splitting of data traffic based at least in part on activating or deactivating one or more learning models via MAC-CE, which allows flexible management of routing and splitting of data traffic using ML models.

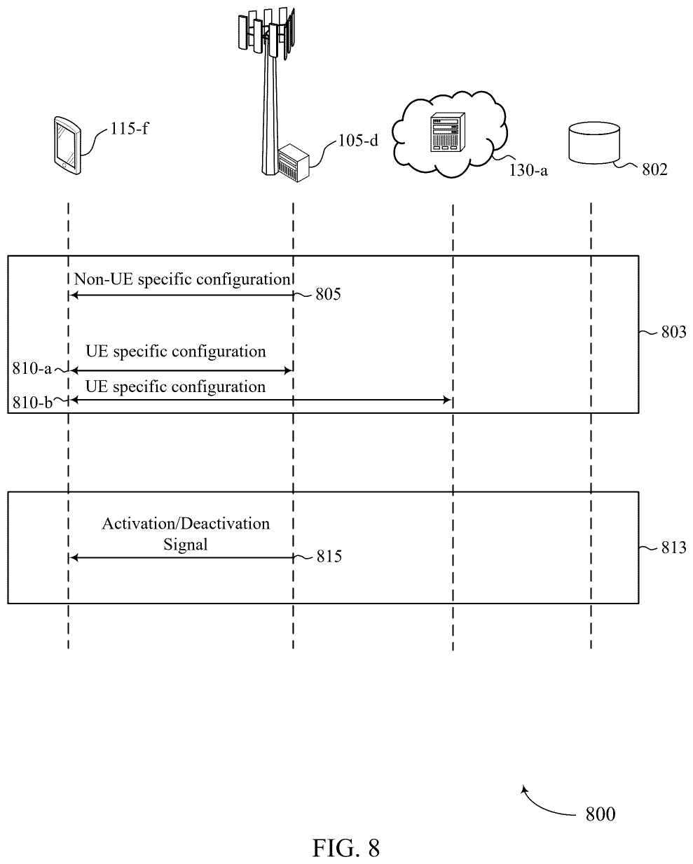

FIG. 8 shows an example of a process flow 800 supports AI-enabled routing and splitting of data traffic in accordance with one or more aspects of the present disclosure. The process flow 800 may implement aspects of the wireless communications system 100 as described with reference to FIG. 1. The process flow 800 may include a UE 115-f, a network entity 105-d, and a core network 130-a, which may be examples of UEs 115, network entities 105, and core networks 130 as described herein. Additionally, the process flow 800 may include a repository 802 (e.g., a database) storing one or more learning models for AI-enabled routing and splitting of data traffic. In the following description of the process flow 800, the operations between the UE 115-f, the network entity 105-d, the core network 130-a, and the repository 802 may be transmitted in a different order than the example order shown, or the operations performed by the UE 115-f, the network entity 105-d, the core network 130-a, and the repository 802 may be performed in different orders or at different times. Some operations may also be omitted from the process flow 800, and other operations may be added to the process flow 800.

In the example of FIG. 8, one or more of the UE 115-f, the network entity 105-d, or the core network 130-a may support performing one or more procedures 803 or 813, which may include an exchange of a set of one or more configurations (or a set of one or more parameters) associated with one or more learning models for AI-enabled routing and splitting of data traffic. For example, one or more of the UE 115-f, the network entity 105-d, or the core network 130-a may support performing one or more procedures, which may exchange of the set of one or more configurations (or the set of one or more parameters) associated with the one or more learning models for AI-enabled routing and splitting of data traffic based at least in part on a state (e.g., an idle state, an inactivate state) of the UE 115-f. In some examples, one or more of the UE 115-f, the network entity 105-d, or the core network 130-a may support activating or deactivating the one or more learning models for AI-enabled routing and splitting of data traffic for inference during the state of the UE 115-f. For example, one or more of the UE 115-f, the network entity 105-d, or the core network 130-a may support activating or deactivating the one or more learning models for AI-enabled routing and splitting of data traffic to perform an inference (e.g., training) of the one or more learning models and cell selection, cell reselection, RLF recovery, measurement operations, random access channel operations (e.g., beam selection, random access channel occasions (RO), and the like).

At 805, the network entity 105-d may transmit, and the UE 115-f may receive, a set of one or more non-UE specific configurations. For example, the network entity 105-d may broadcast, and the UE 115-f may receive, system information including the set of one or more non-UE specific configurations. The system information may include a system information block (SIB). The set of one or more non-UE specific configurations may include one or more sets of one or more parameters, which may be associated with a set of one or more learning models for AI-enabled routing and splitting of data traffic and include a set of one or more identifiers associated with the set of one or more learning models for AI-enabled routing and splitting of data traffic, etc.

Additionally, or alternatively, at 810-a, the network entity 105-d may transmit, and the UE 115-f may receive, for example, via a unicast transmission, a set of one or more UE specific configurations for AI-enabled routing and splitting of data traffic. For example, the network entity 105-d may transmit, and the UE 115-f may receive, an RRC message including the set of one or more UE specific configurations. The set of one or more UE specific configurations may include one or more sets of one or more parameters, which may be associated with a set of one or more learning models including a set of one or more identifiers associated with the set of one or more learning models for AI-enabled routing and splitting of data traffic. In some examples, the RRC message may be an RRC release message during an RRC release procedure. In some examples, at 810-b, one or more of the UE 115-f, the network entity 105-d, or the core network 130-a (e.g., one or more network functions associated with the core network 130-a) may exchange one or more NAS messages associated with the set of one or more UE specific configurations.

At 815, the network entity 105-d may transmit, and the UE 115-f may receive, a signal (also referred to as an activation signal or a deactivation signal) for activating or deactivating one or more learning models for AI-enabled routing and splitting of data traffic. In some examples, the network entity 105-d may transmit, and the UE 115-f may receive, the signal for activating or deactivating the one or more learning models for AI-enabled routing and splitting of data traffic. For example, the network entity 105-d may transmit, and the UE 115-f may receive, a MAC-CE that activates or deactivates the one or more learning models for AI-enabled routing and splitting of data traffic and may perform an inference (e.g., training) of the one or more learning models during an idle state or an inactivate state of the UE 115-f. As such, activating or deactivating the one or more learning models for AI-enabled routing and splitting of data traffic may be based at least in part on the idle state or the inactivate state of the UE 115-f.

Accordingly, one or more of the UE 115-f, the network entity 105-d, or the core network 130-a may support activating or deactivating one or more learning models for AI-enabled routing and splitting of data traffic and for inference of the one or more learning models for AI-enabled routing and splitting of data traffic during an idle state or an inactivate state of the UE 115-f.

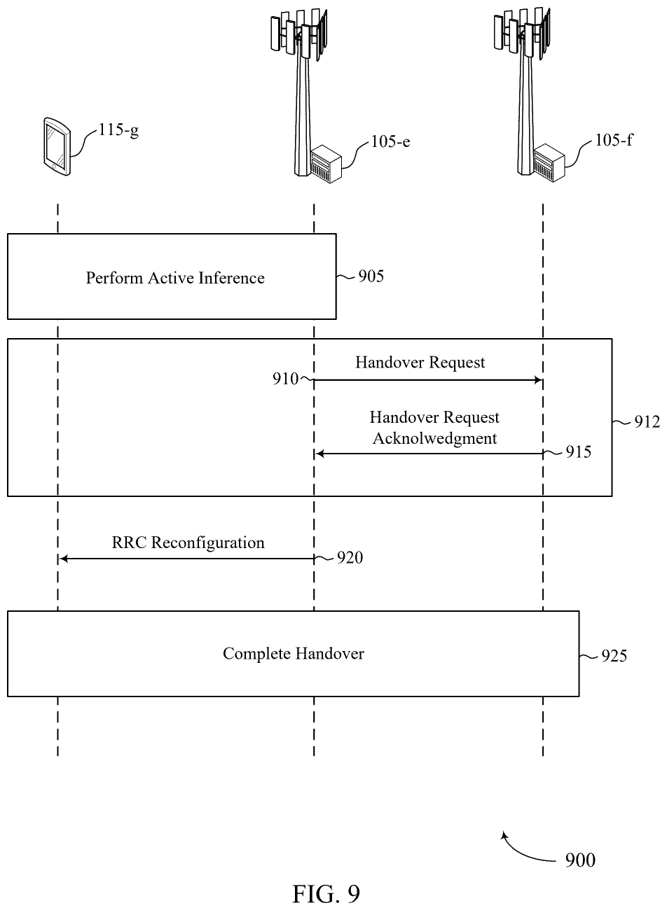

FIG. 9 shows an example of a process flow 900 that supports AI-enabled routing and splitting of data traffic in accordance with one or more aspects of the present disclosure. The process flow 900 may implement aspects of the wireless communications system 100 as described with reference to FIG. 1. The process flow 900 may include a UE 115-g, a network entity 105-e, and a network entity 105-f, which may be examples of UEs 115 and network entities 105 as described herein. In the following description of the process flow 900, the operations between the UE 115-g, the network entity 105-e, and the network entity 105-f may be transmitted in a different order than the example order shown, or the operations performed by the UE 115-g, the network entity 105-e, and the network entity 105-f may be performed in different orders or at different times. Some operations may also be omitted from the process flow 900, and other operations may be added to the process flow 900.

In the example of FIG. 9, one or more of the UE 115-g, the network entity 105-e, and the network entity 105-f may support managing AI-enabled routing and splitting of data traffic during a mobility (also referred to as UE mobility) of the UE 115-g. More specifically, one or more of the UE 115-g, the network entity 105-e, and the network entity 105-f may support managing AI/ML functionality for AI-enabled routing and splitting of data traffic associated with the UE 115-g during a handover procedure, which may include switching (e.g., transferring) a connection of the UE 115-g from the network entity 105-e (also referred to as a source base station) to the network entity 105-f (also referred to as a target base station) and while maintaining ongoing AI/ML functionality for AI-enabled routing and splitting of data traffic.

At 905, one or more of the UE 115-g or the network entity 105-e may perform an active inference (e.g., training) of one or more learning models for AI-enabled routing and splitting of data traffic. The inference (e.g., training) of the one or more learning models for AI-enabled routing and splitting of data traffic may be based at least in part on one or more sets of one or more configurations, including one or more sets of one or more parameters, configured by the network entity 105-e.

At 910, the network entity 105-e may transmit, and the network entity 105-f may receive, a handover request message, which may include context information (e.g., AI/ML context) associated with the one or more learning models for AI-enabled routing and splitting of data traffic, during a handover preparation 912. At 915, the network entity 105-f may transmit, and the network entity 105-e may receive, a handover request acknowledgment message during the handover preparation 912, which may include one or more sets of one or more configurations for AI-enabled routing and splitting of data traffic, including one or more sets of one or more parameters, configured by the network entity 105-f. Put another way, the network entity 105-f may provide a set of one or more AI/ML configurations for the UE 115-g to apply after being handed over to the network entity 105-f by the network entity 105-e. In some examples, the network entity 105-e may determine the sets of one or more configurations for AI-enabled routing and splitting of data traffic, including the one or more sets of one or more parameters, based at least in part on the context information (e.g., AI/ML context) received from the network entity 105-f. Additionally, or alternatively, the network entity 105-e may determine the sets of one or more configurations, including the one or more sets of one or more parameters, based at least in part on one or more of UE capabilities of the UE 115-g or network capabilities of the network entity 105-f. In some examples, one or more of the UE 115-g or the network entity 105-f may support partial or full AI/ML functionality (e.g., enabling of one or more features associated with at least one learning model).

At 920, the network entity 105-e may transmit, and the UE 115-g may receive, an RRC reconfiguration message, which include the sets of one or more configurations for AI-enabled routing and splitting of data traffic, including the one or more sets of one or more parameters, configured by the network entity 105-f. At 925, one or more of the UE 115-g, the network entity 105-e, or the network entity 105-f may complete handover (e.g., a handover of the UE 115-g from the network entity 105-e to the network entity 105-f).

Accordingly, one or more of the UE 115-g, the network entity 105-e, or the network entity 105-f may support managing AI-enabled routing and splitting of data traffic during a mobility of the UE 115-g.

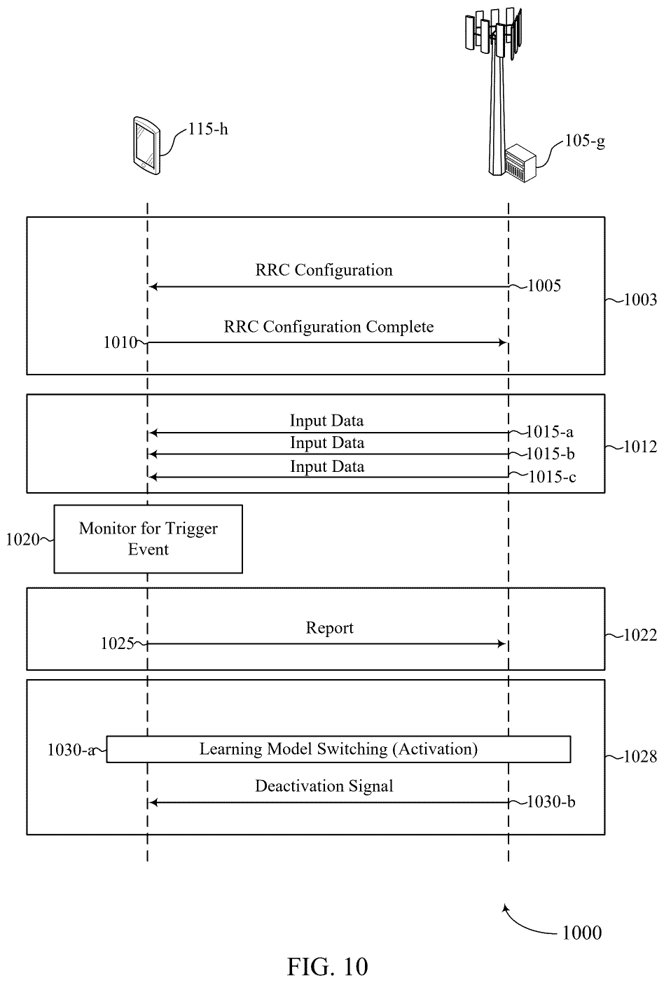

FIG. 10 shows an example of a process flow 1000 that supports AI-enabled routing and splitting of data traffic in accordance with one or more aspects of the present disclosure. The process flow 1000 may implement aspects of the wireless communications system 100 as described with reference to FIG. 1. The process flow 1000 may include a UE 115-h and a network entity 105-g, which may be examples of UEs 115 and network entities 105 as described herein. In the following description of the process flow 1000, the operations between the UE 115-h and the network entity 105-g may be transmitted in a different order than the example order shown, or the operations performed by the UE 115-h and the network entity 105-g may be performed in different orders or at different times. Some operations may also be omitted from the process flow 1000, and other operations may be added to the process flow 1000.

In the example of FIG. 10, one or more of the UE 115-h or the network entity 105-g may support activating and deactivating one or more learning models for AI-enabled routing and splitting of data traffic based at least in part on reporting of feedback associated with the one or more learning models for AI-enabled routing and splitting of data traffic by the UE 115-h.

At 1005, the network entity 105-g may transmit, and the UE 115-h may receive, an RRC message that includes a set of one or more RRC configurations during a procedure 1003 (e.g., an RRC procedure), which may include a set of one or more parameters. In some examples, one or more parameters of the set of one or more parameters may include one or more performance KPIs or one or more system KPIs, or a combination thereof. In some other examples, one or more parameters of the set of one or more parameters may include one or more monitoring events (e.g., thresholds, conditions). In other examples, one or more parameters of the set of one or more parameters may include one or more reporting events, reporting periodicity, etc. At 1010, the UE 115-h may transmit, and the network entity 105-g may receive, an RRC configuration complete message during the procedure 1003 (e.g., the RRC procedure).

At 1012, the network entity 105-g may transmit, and the UE 115-h may receive, input data, which may be input for one or more learning models for AI-enabled routing and splitting of data traffic at the UE 115-h. In some examples, the network entity 105-g may transmit, and the UE 115-h may receive, input data via one or more unicast transmissions. For example, at 1015-a, 1015-b, and 1015-c, the network entity 105-g may transmit, and the UE 115-h may receive, input data via one or more unicast transmissions. In some other examples, the network entity 105-g may broadcast, and the UE 115-h may receive, input data via one or more broadcast transmissions as described herein with reference to FIGS. 3 through 8. For example, at 1015-a, 1015-b, and 1015-c, the network entity 105-g may transmit, and the UE 115-h may receive, input data via one or more broadcast transmissions.

At 1020, the UE 115-h may monitor for one or more events (e.g., threshold satisfied, conditions satisfied) associated with the one or more learning models for AI-enabled routing and splitting of data traffic. At 1025, the UE 115-h may transmit, and the network entity 105-g may receive, a report based at least in part on the one or more events. For example, the UE 115-g may transmit, and the network entity 105-g may receive, the report during a reporting event 1022. The report may indicate the one or more performance KPIs or the one or more system KPIs, or a combination thereof.

At 1030-a, one or more of the UE 115-h or the network entity 105-g may switch between one or more learning models for AI-enabled routing and splitting of data traffic during a switching or deactivation event 1028 as described herein. For example, one or more of the UE 115-h or the network entity 105-g may active at least one learning model of the one or more learning models for AI-enabled routing and splitting of data traffic based at least in part on the reported one or more performance KPIs or the reported one or more system KPIs, or a combination thereof. Additionally, or alternatively, at 1030-b, one or more of the UE 115-h or the network entity 105-g may activate or deactivate at least one learning model of the one or more learning models for AI-enabled routing and splitting of data traffic based at least in part on the reported one or more performance KPIs or the reported one or more system KPIs, or a combination thereof.

Accordingly, one or more of the UE 115-h or the network entity 105-g may support activating and deactivating one or more learning models for AI-enabled routing and splitting of data traffic based at least in part on reported feedback associated with the one or more learning models for AI-enabled routing and splitting of data traffic by the UE 115-h.

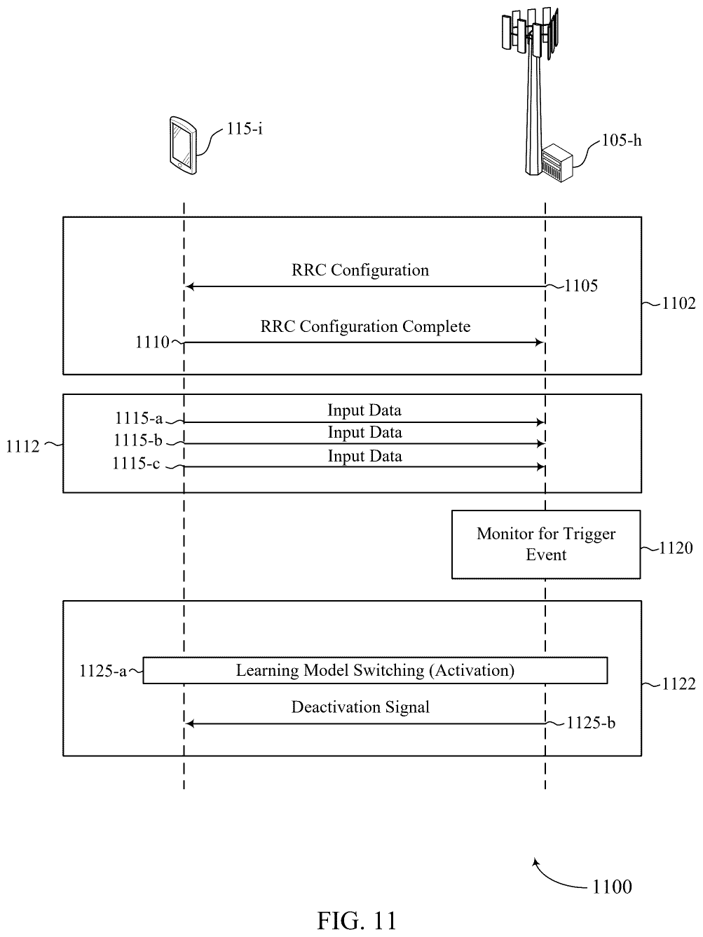

FIG. 11 shows an example of a process flow 1100 that supports AI-enabled routing and splitting of data traffic in accordance with one or more aspects of the present disclosure. The process flow 1100 may implement aspects of the wireless communications system 100 as described with reference to FIG. 1. The process flow 1100 may include a UE 115-i and a network entity 105-h, which may be examples of UEs 115 and network entities 105 as described herein. In the following description of the process flow 1100, the operations between the UE 115-i and the network entity 105-h may be transmitted in a different order than the example order shown, or the operations performed by the UE 115-i and the network entity 105-h may be performed in different orders or at different times. Some operations may also be omitted from the process flow 1100, and other operations may be added to the process flow 1100.

In the example of FIG. 11, one or more of the UE 115-i or the network entity 105-h may support activating and deactivating one or more learning models for AI-enabled routing and splitting of data traffic based at least in part on monitoring by the network entity 105-h of the one or more learning models for AI-enabled routing and splitting of data traffic.

At 1105, the network entity 105-h may transmit, and the UE 115-i may receive, an RRC message that includes set of one or more RRC configurations during a procedure 1102 (e.g., an RRC procedure), which may include a set of one or more parameters. In some examples, one or more parameters of the set of one or more parameters may include one or more performance KPIs or one or more system KPIs, or a combination thereof. At 1110, the UE 115-i may transmit, and the network entity 105-h may receive, an RRC configuration complete message during the procedure 1102 (e.g., the RRC procedure).

At 1112, the network entity 105-h may receive, and the UE 115-i may transmit, input data, which may be input for one or more learning models for AI-enabled routing and splitting of data traffic at the network entity 105-h. In some examples, the network entity 105-h may receive, and the UE 115-i may transmit, input data via one or more unicast transmissions. For example, at 1115-a, 1115-b, and 1115-c, the network entity 105-h may receive, and the UE 115-i may transmit, input data via one or more unicast transmissions. At 1120, the network entity 105-h may monitor for one or more events (e.g., threshold satisfied, conditions satisfied) associated with the one or more learning models for AI-enabled routing and splitting of data traffic at the network entity 105-h.

At 1125-a, one or more of the UE 115-i or the network entity 105-h may switch between one or more learning models for AI-enabled routing and splitting of data traffic based at least in part on one or more events and during a switching or deactivation event 1122 as described herein. For example, one or more of the UE 115-i or the network entity 105-h may active at least one learning model of the one or more learning models for AI-enabled routing and splitting of data traffic based at least in part on the one or more events as described herein. Additionally, or alternatively, at 1125-b, one or more of the UE 115-i or the network entity 105-h may deactivate at least one learning model of the one or more learning models for AI-enabled routing and splitting of data traffic based at least in part on the one or more events as described herein. Accordingly, one or more of the UE 115-i or the network entity 105-h may support activating and deactivating one or more learning models for AI-enabled routing and splitting of data traffic based at least in part on monitoring by the network entity 105-h of the one or more learning models for AI-enabled routing and splitting of data traffic.

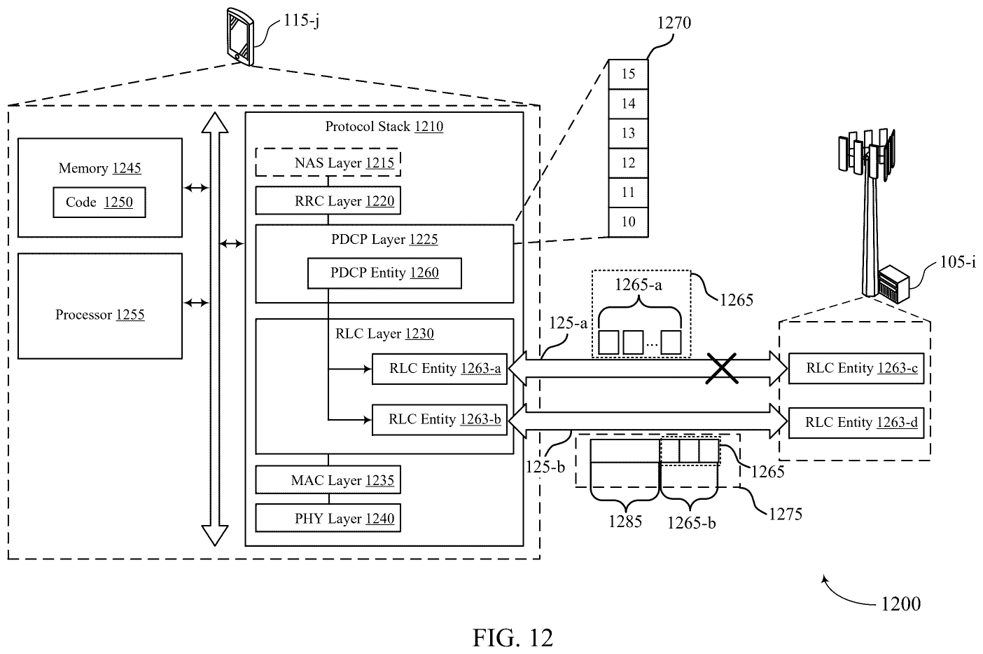

FIG. 12 shows an example of a wireless communications system 1200 that supports AI-enabled routing and splitting of data traffic in accordance with one or more aspects of the present disclosure. The wireless communications system 1200 may implement or be implemented by aspects of the wireless communications system 100 as described herein with reference to FIG. 1. For example, the wireless communications system 1200 may include a UE 115-j and a network entity 105-i, which may be an example of UEs 115 and network entities 105 as described herein with reference to FIG. 1. The wireless communications system 1200 may support 3G, 4G, 5G, or radio access technologies beyond 5G.

The UE 115-j and the network entity 105-i may perform wireless communication (e.g., one or more of receiving, obtaining, transmitting, or outputting one or more of control information or data) via a communication link 125-a and a communication link 125-b, which may be examples of communications links 125 as described herein with reference to FIG. 1. The communication link 125-a may be mapped to or correspond to a first radio frequency spectrum band (e.g., frequency range 1 (FR1)) and the communication link 125-b may be mapped to or correspond to a second radio frequency spectrum band (e.g., frequency range 2 (FR2)). In the example of FIG. 12, the UE 115-j may be equipped (e.g., configured) with at least one protocol stack 1210 to support one or more of receiving, obtaining, transmitting, or outputting one or more of control information or data. The at least one protocol stack 1210 may include one or more protocol layers, which may be ordered in a hierarchical architecture. In some examples, the at least one protocol stack 1210 may be associated with one or more of a control plane (and may be referred to as a control plane protocol stack) or a user plane (and may be referred to as a user plane protocol stack). The at least one protocol stack 1210 may include one or more of a NAS layer 1215, an RRC layer 1220, a PDCP layer 1225, an RLC layer 1230, a MAC layer 1235, or a PHY layer 1240.

The NAS layer 1215 may be capable of, configured to, or operable to support mobility, authentication, and bearer management for the UE 115-j served by the network entity 105-i. The RRC layer 1220 may be capable of, configured to, or operable to support establishment, configuration, and maintenance of a connection between the UE 115-j and the network entity 105-i supporting radio bearers for user plane data. Additionally, the RRC layer 1220 may be capable of, configured to, or operable to support establishment, configuration, and maintenance of a connection between a network entity 105 or a core network 130 supporting radio bearers for user plane data as described herein with reference to FIG. 1. The PDCP layer 1225 may be capable of, configured to, or operable to support header compression, in-sequence delivery, ciphering and integrity protection, transfer of user plane and control plane data, removal of duplicates. Additionally, or alternatively, PDCP layer 1225 may be capable of, configured to, or operable to support routing the split barriers.

The RLC layer 1230 may be capable of, configured to, or operable to support transfer of upper layer PDUs (e.g., a set of PDUs 1265) according one or more modes, including: AM, UN, and TM. The RLC layer 1230 may perform error correction through ARQ, concatenation, segmentation, and reassembly of RLC SDUs, re-segmentation of RLC data PDUs (e.g., the set of PDUs 1265), reordering of RLC data PDUs (e.g., the set of PDUs 1265), duplicate detection, RLC re-establishment and protocol error detection and recovery. The RLC layer 1230 of the UE 115-j may receive RLC SDUs from and/or transmit to upper protocol layers (e.g., the PDCP layer 1225) of the at least one protocol stack 1210 of the UE 115-j, and transmit and/or receive RLC PDUs (e.g., the set of PDUs 1265) to and/or from a peer RLC entity, for example, of the network entity 105-i via lower layers (e.g., the PHY layer 1240) of the at least one protocol stack 1210 of the UE 115-j.

The MAC layer 1235 may be capable of, configured to, or operable to support priority handling and multiplexing of logical channels into transport channels. Additionally, the MAC layer 1235 may be capable of, configured to, or operable to support error detection techniques, error correction techniques, or both to support retransmissions to improve link efficiency. The PHY layer 1240 may be capable of, configured to, or operable to support mapping transport channels to physical channels. Additionally, the PHY layer 1240 may be capable of, configured to, or operable to support coding/decoding, modulation/demodulation, multiantenna mapping, etc.

In some cases, the UE 115-j may be configured with a split bearer. That is, the PDCP entity 1260 (e.g., of the PDCP layer 1225) may be capable of splitting PDUs of the set of PDUs 1265 of a PDCP buffer 1270 into two data paths. A primary data path may be via the RLC entity 1263-a and a secondary data path may be via the RLC entity 1263-b. The RLC entity 1263-a of the UE 115-j may correspond to the RLC entity 1263-c of the network entity 105-i and the RLC entity 1263-b of the UE 115-j may correspond to the RLC entity 1263-d of the network entity 105-i. The two data paths may include two bidirectional UM RLC entities, four unidirectional UM RLC entities, or two AM RL entities. The PDCP entity 1260 may be configured with a data volume threshold (e.g., ul-DataSplitThreshold) that indicates to the PDCP entity 1260 a condition that, once satisfied, enables the PDCP entity 1260 to split PDUs of the set of PDUs 1265 over the two paths (e.g., as opposed to forwarding all PDUs of the PDCP buffer 1270 to the primary RLC entity 1263-a). The data volume threshold (e.g., uplink data volume threshold) may be a static parameter that is configured at the UE 115-j (e.g., at the PDCP entity 1260, at a splitting function) during bearer establishment. The PDCP entity 1260 may forward (e.g., submit) the set of PDUs 1265 from the PDCP buffer to a single RLC entity (e.g., RLC entity 1263-a or RLC entity 1263-b, but not both). In this way, the set of PDUs 1265 are not duplicated over both the RLC entity 1263-a and the RLC entity 1263-b. Rather, a single RLC entity (e.g., the RLC entity 1263-a or the RLC entity 1263-b) is responsible for successfully transmitting the set of PDUs 1265. The PDCP entity 1260 buffers the set of PDUs 1265 until a discard timer expires or until successful transmission of the set of PDUs 1265 is confirmed by lower layers (e.g., RLC layer 1230, MAC layer 1235). Splitting of the set of PDUs 1265 by the PDCP entity 1260 may be based on a total amount of PDCP data volume and RLC data volume, that is pending transmission at the RLC entity 1263-a and the RLC entity 1263-b, satisfying the data volume threshold.

To determine routing of each of one or more PDUs of the set of PDUs 1265 to one of the RLC entity 1263-a or the RLC entity 1263-b, the PDCP entity 1260 may mirror (e.g., copy, handle) a grant assignment by the network entity 105-i. That is, the UE 115-j may lack autonomy of routing each of one or more PDUs of the set of PDUs 1265 to one of the RLC entity 1263-a and the RLC entity 1263-b, and the UE 115-j may instead follow instructions or indications that the UE 115-j receives from the network entity 105-i with respect to whether each of one or more PDUs of the set of PDUs 1265 are forwarded or submitted to the RLC entity 1263-a or the RLC entity 1263-b. To determine the total amount of PDCP data volume and RLC data volume (e.g., for comparing against the data volume threshold), the UE 115-j may calculate the total amount of data volume (e.g., layer 1 (L1) data volume) as a sum of PDCP SDUs, PDCP data PDUs (e.g., one or more PDUs of the set of PDUs 1265), PDCP control PDUs (e.g., one or more PDUs of the set of PDUs 1265), PDCP SDUs that are transmitted for PDCP reestablishment, and PDCP PDUs (e.g., one or more PDUs of the set of PDUs 1265) retransmitted for PDCP recovery. In some examples, based on the total data volume (e.g., PDCP data volume plus RLC data volume) satisfying the data volume threshold, the PDCP entity 1260 may indicate to one or more MAC entities (e.g., a first MAC entity of the MAC layer 1235 associated with the RLC entity 1263-a and a second MAC entity of the MAC layer 1235 associated with the RLC entity 1263-b) the PDCP data volume at the PDCP layer 1225, and the one or more MAC entities may use the PDCP data volume for buffers status report (BSR) calculation.

In some examples, the data volume threshold may be relatively high (e.g., above a threshold) which may prevent the PDCP entity 1260 from forwarding each of one or more PDUs of the set of PDUs 1265 of the PDCP buffer 1270 to the RLC entity 1263-b. The PDCP buffer 1270 may include one or more PDUs of the set of PDUs 1265 that may be ready or pending transmission at the UE 115-j. Each of one or more PDUs of the set of PDUs 1265 may correspond to a respective sequence number (SN) (e.g., SN 10, SN 11, SN 12, SN 13, SN 14, SN 15). In some examples, there may be a backlog of PDUs (e.g., one or more PDUs 1265-a of the set of PDUs 1265) at the RLC entity 1263-a due to a degradation of the RLC entity 1263-a, such as channel quality metrics dropping below a threshold or a radio link failure. Accordingly, the PDCP entity 1260 may begin routing the PDUs to the RLC entity 1263-b (e.g., instead of the RLC entity 1263-a) based on a total volume of data at L2 of the UE 115-j satisfying the data volume threshold.

By way of example, the PDCP entity 1260 may forward one or more PDUs 1265-b of the set of PDUs 1265, corresponding to SN 10, SN 11, and SN 12, to the RLC entity 1263-b for transmission to the network entity 105-I (e.g., to an RLC entity 1263-d of the network entity 105-i). However, after forwarding the one or more PDUs 1265-b to the RLC entity 1263-b, the PDCP entity 1260 may determine that the PDCP data volume (e.g., a data volume associated with the PDCP buffer 1270) drops below the data volume threshold, and splitting of data traffic to both the RLC entity 1263-a and the RLC entity 1263-b may be disabled. The one or more PDUs 1265-b may be included in an uplink grant 1275. The uplink grant 1275 may have additional space available, which may correspond to padding 1285 in the uplink grant 1275. However, the UE 115-j is unable to utilize the additional space in the uplink grant 1275 at the RLC entity 1263-b because the data volume satisfies the data volume threshold. As a result, one or more PDUs of the set of PDUs 1265 corresponding to SNs 12 through 15 may be delayed due to degradation at the RLC entity 1263-a despite availability of resources (e.g., padding 1285) in the RLC entity 1263-b.

In some examples, the configuration of routing or splitting of data traffic that is based on the network entity configured value of the data volume threshold may result in high PDCP reordering delays at a PDCP entity of the network entity 105-i. For example, the UE 115-j may attempt to transmit one or more PDUs 1265-a of the set of PDUs 1265 that correspond to SN 10. The UE 115-j may transmit multiple retransmissions of the one or more PDUs 1265-a (e.g., due to relatively poor radio link quality of the communication link 125-a corresponding to the RLC entity 1263-a). PDUs 1265-b of the set of PDUs 1265, which may correspond to SNs 11-15, may be successfully rerouted (e.g., split, forwarded) to the RLC entity 1263-b and may be successfully transmitted via the communication link 125-b. Because the one or more PDUs 1265-b of the set of PDUs 1265 corresponding to SNs 11-15 may be successfully received at a PDCP entity of the network entity 105-i (e.g., via the RLC entity 1263-d) but the one or more PDUs 1265-b of the set of PDUs 1265 corresponding to SN 10 may not be received (e.g., may be in the process of being retransmitted), a PDCP hole may exist at the PDCP entity of the network entity 105-i. Thus, a reception time window associated with the SNs 10-15, which may be based on successful reception of each of the SNs 10-15, may be impacted by delay. Moreover, based on transmitting the SNs 11-15 successfully by the UE 115-j, a total data volume at the UE 115-j (e.g., a data volume of the PDCP layer 1225, a data volume of the RLC layer 1230, or both) may fall below the data volume threshold, which may result in a disabling of RLC splitting and any additional SNs of the PDCP buffer 1270 being routed to the RLC entity 1263-a.

In the example of FIG. 12, the UE 115-j (e.g., including the PDCP entity 1260 of the UE 115-j) may support autonomous selection of the data volume threshold (e.g., ul-DataSplitThreshold) to apply to PDCP splitting of data traffic. The selected value of the data volume threshold may be based on an AI/ML model at the UE 115-j, a range of values (e.g., bounds) or performance metrics indicated by the network entity 105-i, or both. In some examples, KPIs may indicate performance metrics such as a threshold quantity of data, or a threshold quantity of instances, that the UE 115-j is permitted to transmit on the RLC entity 1263-b without routing one or more PDUs (e.g., one or more PDUs 1265-a) of the set of PDUs 1265 to the RLC entity 1263-a, among other performance metrics. In some examples, the range of values, the performance metrics, or other parameters, may be inputs to the AI/ML model at the UE 115-j. Other parameters that may be input to the AI/ML model for selection of the data volume threshold may include a reordering delay at the PDCP entity of the network entity 105-i. The reordering delay at the PDCP entity of the network entity 105-i may be an actual value, reported by the network entity 105-i, or a predicted value, predicted by the UE 115-j (e.g., as an output to the AI/ML model) based on an estimation by the UE 115-j of radio conditions associated with one or more of the communication link 125-a and the communication link 125-b, a predicted delay associated with the one or more PDUs 1265-a of the set of PDUs 1265 transmitted via the RLC entity 1263-a, a predicted delay associated with the one or more PDUs 1265-b of the set of PDUs 1265 transmitted via the RLC entity 1263-b, or a combination thereof.

In some implementations, the UE 115-j may report the selected data volume threshold value (e.g., ul-DataSplitThreshold) to the network entity 105-i. The UE 115-j may transmit the selected data volume threshold to the network entity 105-i via a RRC message, a PDCP data PDU (e.g., a PDU of the set of PDUs 1265), a PDCP control PDU (e.g., a PDU of the set of PDUs 1265), or a MAC-control element (MAC-CE). In some examples, the UE 115-j may update the data volume threshold value (e.g., without input or confirmation from the network entity 105-i, autonomously), and the UE 115-j may indicate to the network entity 105-i that the UE 115-j is applying the updated data volume threshold value for PDCP splitting determinations. In some other examples, the UE 115-j may request for the network entity 105-i to update (e.g., reconfigure) the data volume threshold based on the selected value by the UE 115-j. In such examples, the network entity 105-i may respond to the recommendation from the UE 115-j with a MAC-CE to reconfigure the data volume threshold. The MAC-CE may include an acknowledgement or non-acknowledgment to approve/reject the UE 115-j recommendation, or may indicate a value different from the value indicated by the UE 115-j, or a combination thereof. In some examples, the network entity 105-i may perform a PDCP reconfiguration based on receiving the indication of the selected value from the UE 115-j.

In some implementations, the network entity 105-i may configure the UE 115-j to override the data volume threshold based on the presence of padding 1285 in one or more uplink grants 1275 of the RLC entity 1263-b. For example, the UE 115-j, or the network entity 105-i, may observe or predict that there are available resources in the RLC entity 1263-b for transmission of one or more PDUs of the set of PDUs 1265. The UE 115-j (e.g., the PDCP entity 1260 of the UE 115-j) may submit one or more PDUs of the set of PDUs 1265 to the RLC entity 1263-b irrespective of the data volume at the PDCP layer 1225, the data volume at the RLC layer 1230, or both. The UE 115-j may submit the one or more PDUs of the set of PDUs 1265 to the RLC entity 1263-b based on the one or more PDUs of the set of PDUs 1265 occupying full or partial grants (e.g., that may otherwise go unused by the UE 115-j).

By enabling the UE 115-j (e.g., including the RLC layer 1230 of the UE 115-j) to support autonomous selection of the data volume threshold for routing or splitting of data traffic by the PDCP entity 1260, the UE 115-j (e.g., including the RLC layer 1230 of the UE 115-j) may reduce transmission and reordering delays, which may increase efficiency of communications and reduce latencies. Additionally, or alternatively, by enabling the UE 115-j (e.g., including the RLC layer 1230 of the UE 115-j) to support autonomous selection of the data volume threshold for routing or splitting of data traffic (e.g., RLC data PDUs) by the PDCP entity 1260, the UE 115-j (e.g., including the RLC layer 1230 of the UE 115-j) may support efficient use of resources. For example, the UE 115-j (e.g., including the RLC layer 1230 of the UE 115-j) may continue to perform uplink communication over an RLC entity 1263-b and clear the PDCP buffer 1270 of the PDCP layer 1225 despite degradation or relatively poor channel quality associated with the communication link 125-a associated with the RLC entity 1263-a (e.g., which may be a primary RLC path).

In some implementations, the network entity 105-i may configure the UE 115-j to disable (e.g., refrain from routing to) the RLC entity 1263-a for a duration. The disabling of the RLC entity 1263-a may be based on a prediction or measurement by the UE 115-j (e.g., an output of the AI/ML model) that routing to the RLC entity 1263-a slows down the reordering window (e.g., at the PDCP entity of the network entity 105-i), or that a channel quality indicator (CQI) of the communication link 125-a associated with the RLC entity 1263-a satisfies a threshold, or a combination thereof. In some examples, the UE 115-j may perform disabling of one or more RLC entities (e.g., one or more of the RLC entity 1263-a or the RLC entity 1263-b) autonomously, without a trigger from the network entity 105-i (e.g., based on one or more outputs of an AI/ML learning model). In some examples, the network entity 105-i may indicate one or more criteria for disabling of RLC entities (e.g., one or more of the RLC entity 1263-a or the RLC entity 1263-b), such as a threshold frequency for disabling or a threshold quantity of disables by the UE 115-j. In some examples, disabling of the RLC entity 1263-a may be based on one or more outputs of an AI/ML learning model (e.g., a third set of parameters). In some examples, the AI/ML model may produce one or more thresholds, and the UE 115-j may disable the RLC entity 1263-a based on satisfaction of the one or more thresholds. For example, the one or more outputs of the AI/ML model may include, or may be based on, a ratio of a first CQI of the RLC entity 1263-a and a second CQI of the RLC entity 1263-b, a ratio of a first latency (e.g., measured or predicted) associated with the RLC entity 1263-a and a second latency (e.g., measured or predicted) associated with the RLC entity 1263-b, a first HARQ failure rate (e.g., measured or predicted) associated with the RLC entity 1263-a and a second HARQ failure rate (e.g., measured or predicted) associated with the RLC entity 1263-b, or a combination thereof.

In some implementations, the UE 115-j may (e.g., based on a configuration from the network entity 105-i) perform autonomous PDCP data recovery from the RLC entity 1263-a (e.g., which may be disabled) to the RLC entity 1263-b. For example, rather than attempting retransmissions of a PDU of the set of PDUs 1265 associated with the SN 10, the UE 115-j may transfer (e.g., route), as part of a PDCP data recovery procedure, at least the PDU of the set of PDUs 1265 associated with the SN 10 from the RLC entity 1263-a to the RLC entity 1263-b. Performing the PDCP data recovery procedure may be based on disabling the RLC entity 1263-a. In some implementations, the UE 115-j may (e.g., based on a configuration from the network entity 105-i) switch a primary RLC path for uplink data transmission. For example, the UE 115-j may switch from the RLC entity 1263-a as the primary RLC path to the RLC entity 1263-b as the primary RLC path. In some cases, switching the primary RLC path may be based on disabling the RLC entity 1263-a.

The UE 115-j may be equipped with memory 1245 and processor 1255. One or more of the at least one protocol stack 1210, memory 1245, or processor 1255 may be in electronic communication or otherwise coupled (e.g., operatively, communicatively, functionally, electronically, electrically) via one or more buses (or interfaces). The memory 1245 may store computer-readable, computer-executable, or processor-executable code, such as code 1250. The processor 1255 may include one or more intelligent hardware devices (e.g., one or more general-purpose processors, one or more DSPs, one or more central processing units (CPUs), one or more graphics processing units (GPUs), one or more neural processing units (NPUs)), or any combination thereof).

The processor 1255 may be configured to execute computer-readable instructions stored in the memory 1245 to cause the UE 115-j to perform various functions. For example, the code 1250 may include instructions (e.g., based at least in part on a set of one or more configurations) that, when executed by the at least one processor 1255, causes the UE 115-j (e.g., one or more protocol layers of the at least one protocol stack 1210) to perform various functions (e.g., actions) described herein. The set of one or more configurations may include one or more of at least one rule (e.g., a routing or splitting rule), at least one parameter associated with multiple values (e.g., a range of values), a set of one or more other parameters, etc. For example, the code 1250 may be associated with one or more learning models (e.g., AI/ML models). In the example of FIG. 12, the code 1250 may include instructions that, when executed by the at least one processor 1255, causes the UE 115-j (e.g., including the RLC layer 1230 of the UE 115-j) to process one or more PDUs (e.g., RLC data PDUs) of the set of PDUs 1265 according to one or more learning models (e.g., one or more AI/ML models) and at least one value of the multiple values (e.g., a range of values) of the at least one parameter. For example, the UE 115-j (e.g., including the RLC layer 1230 of the UE 115-j) may process one or more PDUs 1265-b (e.g., RLC data PDUs) of the set of PDUs 1265 at the RLC entity 1263-b. The one or more learning models (e.g., one or more AI/ML models) for AI-enabled routing and splitting of data traffic may improve efficient processing (e.g., routing, splitting) of one or more PDUs 1265 of the set of PDUs 1265 at the UE 115-j (e.g., including the RLC layer 1230 of the UE 115-j).

In the example of FIG. 12, the UE 115-j may transmit, and the network entity 105-i may receive, a report including capability information (e.g., UE capability information) that indicates whether the UE 115-j supports AI/ML functionality, including one or more learning models for AI-enabled routing and splitting of data traffic. The capability information may include one or more information elements (IEs), fields (e.g., bit fields), or the like. The one or more IEs or fields, for example, may include information, such as an identifier of a learning model for AI-enabled routing and splitting of data traffic supported by the UE 115-j, a feature of the learning model for AI-enabled routing and splitting of data traffic supported by the UE 115-j, or other context (e.g., labels, metadata, timestamps, etc.) of the learning model for AI-enabled routing and splitting of data traffic supported by the UE 115-j, among other examples. Additionally, or alternatively, the capability information may indicate a capability of the UE 115-j to predict and/or autonomously select the data volume threshold (e.g., ul-dataSplitThreshold), a capability of the UE 115-j to autonomously disable an RLC entity (e.g., one or more of the RLC entity 1263-a or the RLC entity 1263-b, or both) for a duration (e.g., temporarily), a capability of the UE 115-j to perform PDCP data recovery, or a combination thereof. In some examples, the capability information may indicate one or more accuracy metrics of the AI/ML model deployed at the UE 115-j. For example, the capability information may indicate an accuracy of the AI/ML model for predicting an end-to-end latency, for predicting a CQI of one or more RLC entities (e.g., one or more of the RLC entity 1263-a or the RLC entity 1263-b, or both).

The network entity 105-i may generate, determine, or select one or more configurations of a set of one or more configurations associated with one or more learning models for AI-enabled routing and splitting of data traffic based at least in part on the capability information (e.g., UE capability information) that indicates whether the UE 115-j supports AI/ML functionality, including the one or more learning models for AI-enabled routing and splitting of data traffic. The network entity 105-i may transmit, and the UE 115-j may receive, at least one configuration (e.g., an RRC configuration) of the set of one or more configurations associated with at least one learning model for AI-enabled routing and splitting of data traffic The at least one configuration may enable the UE 115-j (e.g., including the RLC layer 1230 of the UE 115-j) to process (e.g., route, skip), via the at least one learning model for AI-enabled routing and splitting of data traffic, partially received PDUs of the set of PDUs 1265 or undelivered PDUs of the set of PDUs 1265 (i.e., not received PDUs 1265) of the set of one or more PDUs (e.g., RLC data PDUs) of the set of PDUs 1265. Additionally, the set of one or more configurations may include a reporting configuration for reporting (e.g., periodically, aperiodically) by the UE 115-j of one or more of a status PDU or one or more dropped PDUs as described herein.

The at least one configuration may include a first set of one or more parameters for a routing and splitting of data traffic procedure (e.g., AI-enabled routing and splitting of data traffic). The first set of one or more parameters for AI-enabled routing and splitting of data traffic may include at least one parameter (e.g., “ul-DataSplitThresholdMin”), which may indicate a first threshold value (e.g., a minimum value) for the uplink data volume threshold (e.g., for selection at the UE 115-j). The first set of one or more parameters for AI-enabled routing and splitting of data traffic may include at least one parameter (e.g., “DataSplitThresholdMax”), which may indicate a second threshold value (e.g., a maximum value) for the uplink data volume threshold. For example, the UE 115-j (e.g., including the RLC layer 1230 of the UE 115-j) may select a value for ul-DataSplitThreshold from a range of values for the ul-DataSplitThreshold that spans from DataSplitThresholdMin to DataSplitThresholdMax. Additionally, or alternatively, the first set of one or more parameters for AI-enabled routing and splitting of data traffic may include at least one parameter (e.g., “RLC-leg-Maximum-missed-grants-Bytes”), which may indicate a threshold quantity of grants allowable for the UE 115-j to miss for the RLC entity 1263-a of the UE 115-j. For example, the UE 115-j may override the network configured data volume threshold until the threshold quantity of grants missed is satisfied. The threshold quantity of grants missed on the RLC entity 1263-a may be evaluated over a configured time window, and once the threshold is met, the UE 115-j may fall back (e.g., return) to a behavior configured by the network entity 105-i (e.g., a previous configured value for the data volume threshold). Additionally, or alternatively, the first set of one or more parameters for AI-enabled routing and splitting of data traffic may include at least one parameter (e.g., “RLC-leg-Disable”), which may indicate whether the UE 115-j is configured to disable at least one of the RLC entity 1263-a or the RLC entity 1263-b.

The first set of one or more parameters may include at least one parameter (e.g., “RLC-leg-Disable-DataRecovery”), which may indicate whether data recovery is configured in response to at least one of the RLC entity 1263-a or the RLC entity 1263-b being disabled. The first set of one or more parameters may include at least one parameter (e.g., “RLC-leg-Disable-Max-Time”), which may indicate a threshold duration for disabling at least one of the RLC entity 1263-a or the RLC entity 1263-b. The first set of one or more parameters may include at least one parameter (e.g., “RLC-leg-Prohibit-Timer”), which may indicate a threshold duration for satisfying prior to disabling at least one of the RLC entity 1263-a or the RLC entity 1263-b (e.g., between successive disables of an RLC entity, such as one or more of the RLC entity 1263-a or the RLC entity 1263-b, or both). In some examples, the first set of one or more parameters may include at least one parameter (e.g., “Primary-path-switch”), which may indicate whether primary path switching (e.g., autonomous RLC path switching, temporary RLC path switching for a duration) is allowed for at least one of the RLC entity 1263-a or the RLC entity 1263-b. Additionally, or alternatively, the first set of one or more parameters may include at least one parameter (e.g., “RLC-leg-min-CQI-to-disable”), which may indicates a channel quality indicator value (e.g., measured or predicted) or a reference signal received power (RSRP) (e.g., measured or predicted) for satisfying prior to disabling at least one of the RLC entity 1263-a or the RLC entity 1263-b. In some examples, the first set of one or more parameters may include at least one parameter (e.g., “AIML_Allowed”), which may indicate whether a learning model (e.g., AI/ML model for routing and splitting of data traffic) is enabled or disabled. The first set of one or more parameters may include at least one parameter (e.g., “QoSFlowsAllowed”), which may indicate whether the learning model (e.g., AI/ML model for routing and splitting of data traffic) is enabled or disabled for a Quality-of-Service (QOS) flow associated with the set of PDUs 1265.

In some examples, the UE 115-j (e.g., including the RLC layer 1230 of the UE 115-j) may be configured to select at least one value of a plurality of values associated with at least one parameter of the first set of one or more parameters, for example, according to the learning model for AI-enabled routing and splitting of data traffic. Each of the one or more parameters of the first set of one or more parameters may be associated with a corresponding range of values, a set of performance metrics, or a combination thereof. The UE 115-j (e.g., including the RLC layer 1230 of the UE 115-j) may, according to the learning model for AI-enabled routing and splitting of data traffic and one or more parameters of the second set of one or more parameters, select a value for the at least one parameter of the first set of one or more parameters. The UE 115-j (e.g., including the RLC layer 1230 of the UE 115-j) may process one or more PDUs of the set of PDUs 1265 according to the learning model for AI-enabled routing and splitting of data traffic and the selected value for the at least one parameter of the first set of one or more parameters.

In some examples, the UE 115-j may be configured with a second set of one or more parameters associated with the at least one learning model for AI-enabled routing and splitting of data traffic and handle (e.g., maintain, update, modify, adjust, track) the second set of one or more parameters associated with the at least one learning model for AI-enabled routing and splitting of data traffic In some examples, some parameters of the first set of one or more parameters may be part of the second set of one or more parameters. In some other examples, some parameters of the second set of one or more parameters may be part of the first set of one or more parameters. The second set of one or more parameters may include one or more radio properties of different RLC entities (e.g., the RLC entity 1263-a and the RLC entity 1263-b). For example, the second set of parameters may include at least one parameter that indicates a performance of a HARQ process (e.g., a HARQ failure rate) for one or more of the RLC entity 1263-a or the RLC entity 1263-b. The second set of parameters may include at least one parameter that indicates a performance of an RLC process (e.g., RLC failure rate, RLC latency, end-to-end delay) for one or more of the RLC entity 1263-a or the RLC entity 1263-b.

In the example of FIG. 12, the UE 115-j may generate and transmit, to the network entity 105-i, a report associated with at least one learning model for AI-enabled routing and splitting of data traffic. The report may include one or more logs associated with processing (e.g., routing, splitting) one or more PDUs 1265 (RLC data PDUs) of the set of PDUs 1265 according to the at least one learning model for AI-enabled routing and splitting of data traffic. Additionally, or alternatively, the one or more logs may include a set of previous selected values for the data volume threshold, CQI and/or RSRP measurements (e.g., or predictions) over the RLC entity 1263-a and the RLC entity 1263-b, CQI thresholds used in determining whether to disable RLC entities 1263 (e.g., one or more of the RLC entity 1263-a or the RLC entity 1263-b), statistics or a log per SN of an end-to-end delay measured on the RLC entity 1263-a and the RLC entity 1263-b (e.g., for each PDU of the set of PDUs 1265 transmitted on that RLC entity), measurements or thresholds that triggered a disabling of the RLC entity 1263-a and or the RLC entity 1263-b, an indication of one or more PDCP data recovery procedures performed by the UE 115-j (e.g., to route one or more PDUs of the set of PDUs 1265 from the RLC entity 1263-a to the RLC entity 1263-b), or a combination thereof.

Accordingly, the report, including the one or more logs, may facilitate one or more of the UE 115-j or the network entity 105-i to obtain information about the impact to the wireless communication for one or more of the UE 115-j or the network entity 105-i associated with processing (e.g., routing, splitting) the set of PDUs 1265. For example, the one or more of the UE 115-j or the network entity 105-i may identify impact on QoS based at least in part on the report, including the one or more logs. One or more of the UE 115-j or the network entity 105-i may determine whether to drop a single PDU of the set of PDUs 1265 (sequence number) and maintain a channel for wireless communication (e.g., receive, transmit) of other PDUs 1265 with lower latency. For example, one or more of the UE 115-j or the network entity 105-i via at least one learning model for AI-enabled routing and splitting of data traffic may analyze QoS associated with splitting PDUs of the set of PDUs 1265 (e.g., routing function, QoS).

In some implementations, the UE 115-j may be configured (e.g., from the network entity 105-i) with target KPIs that may inform the determination by the UE 115-j of routing or splitting of data traffic. In some examples, the target KPIs may be included in the first set of parameters and may be inputs to the AI/ML learning model for routing and splitting of data traffic. The target KPIs may include at least one parameter (e.g., OutOfOrderDelivery) that indicates a first criterion (e.g., threshold) associated with an order of transmission or reception of the set of PDUs 1265 (e.g., as a result of the PDCP splitting performed by the UE 115-j). For example, the parameter may indicate a threshold quantity of data that is delivered out of order by the UE 115-j, a threshold quantity of instances of out of order data delivery by the UE 115-j, or both. The target KPIs may include at least one parameter (e.g., RLCRetransmissions) that indicates a second criterion (e.g., threshold) associated with retransmission of one or more PDUs of the set of PDUs 1265. For example, the parameter may indicate a quantity (e.g., a count, a threshold quantity) of RLC retransmissions as a result of the PDCP splitting performed by the UE 115-j. The target KPIs may include at least one parameter (e.g., LatencyBound) that indicates a third criterion associated with a latency of transmission, reception, or retransmission of one or more PDUs of the set of PDUs 1265 (e.g., or uplink grants 1275). The target KPIs may include at least one parameter (e.g., ReorderingWindowExpiry) that indicates a fourth criterion associated with a reordering window for one or more PDUs of the set of PDUs 1265. For example, the parameter may correspond to a threshold quantity of instances of expiration of the reordering window.

In some examples, the UE 115-j may record and/or store various measurements and may compare the measurements with the target KPIs to determine a coherence, or a lack of coherence, with the target KPIs. In some examples, the UE 115-j may determine that the UE 115-j (e.g., measurements of the UE 115-j, a performance of the UE 115-j) does not satisfy one or more target KPIs. In such examples, the UE 115-j may fallback to a data volume threshold previously configured by the network entity 105-i. In some examples, the UE 115-j may adopt the minimum or maximum data volume threshold indicated by the first set of parameters. Additionally, or alternatively, the UE 115-j may transmit a report to the network entity 105-i, a server associated with the AI/ML learning model, or both indicating the failure of the UE 115-j (e.g., a violation by the UE 115-j) to satisfy one or more target KPIs. In some other examples, the UE 115-j may disable AI/ML learning models and/or predictions for one or more bearers (e.g., PDCP entities 1260), for one or more QoS flows, or both.

In some examples, the network entity 105-i may determine whether the UE 115-j satisfies one or more target KPIs, and the network entity 105-i may transmit a report to the UE 115-j indicating a performance of the UE 115-j relative to the target KPIs (e.g., conformance, non-conformance). In response to the report from the network entity 105-i, the UE 115-j may fallback to a non-AI behavior for routing or splitting of data traffic, may disable one or more AI/ML learning models, may modify one or more configurations of PDCP splitting, or a combination thereof.

Accordingly, the wireless communications system 1200, including one or more of the UE 115-j or the network entity 105-i may support processing of PDUs (e.g., RLC data PDUs) of the set of PDUs 1265 according to a learning model (e.g., an AI/ML model) for AI-enabled routing and splitting of data traffic, the UE 115-j or the network entity 105-i, may experience reduced latency due to more efficient clearing of PDCP buffers 1270 at the UE 115-j and/or accurate and efficient processing of PDUs of the set of PDUs 1265, among other examples. It should be understood that alternative techniques may be realized to support improvement one or more aspects of the present disclosure.

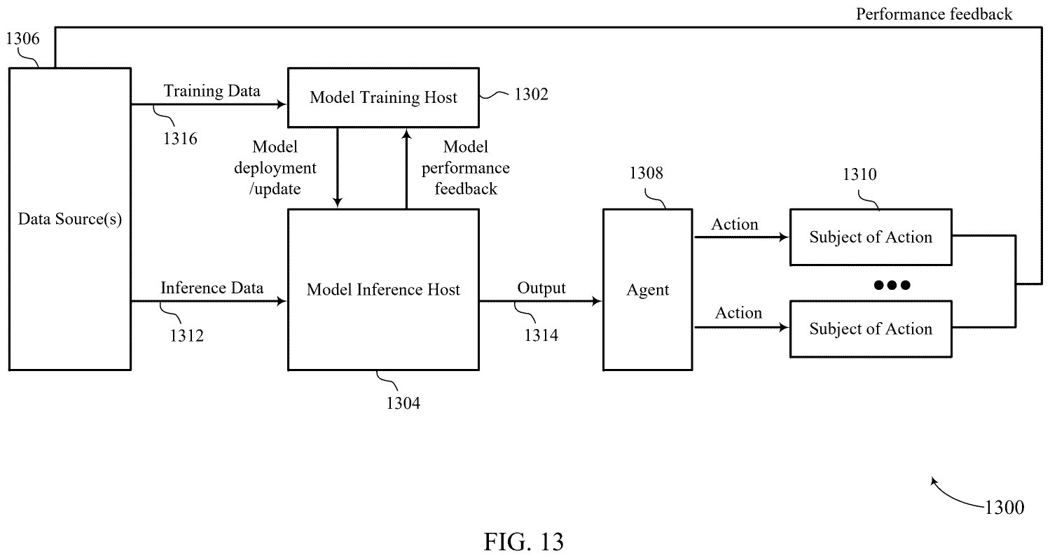

FIG. 13 is an illustrative block diagram of an example ML architecture 1300 that may be used for wireless communications in accordance with one or more aspects of the present disclosure. The ML architecture 1300 may be used for wireless communications in any of the various implementations, processes, environments, networks, or use cases listed above. As illustrated, architecture 1300 includes multiple logical entities, such as model training host 1302, model inference host 1304, data source(s) 1306, and agent 1308. Model inference host 1304 is configured to run an ML model based on inference data 1312 provided by data source(s) 1306. Model inference host 1304 may produce output 1314, which may include a prediction or inference, such as a discrete or continuous value based on inference data 1312, which may then be provided as input to the agent 1308.

Agent 1308 may represent an element or an entity of a wireless communication system including, for example, a radio access network (RAN), a wireless local area network, a device-to-device (D2D) communications system, etc. As an example, agent 1308 may be a UE (e.g., UE 115 as described with reference to FIGS. 1 through 12 and 13 through 18), a base station (e.g., a base station 140 as described with reference to FIG. 1), or a disaggregated network entity (such as a CU, a DU, or a RU as described with reference to FIG. 1), an access point, a wireless station, a RIC in a cloud-based RAN, among some examples. Additionally, agent 1308 also may be a type of agent that depends on the type of tasks performed by model inference host 1304, the type of inference data 1312 provided to model inference host 1304, or the type of output 1314 produced by model inference host 1304.

Agent 1308 may perform one or more actions associated with receiving output 1314 from model inference host 1304. For example, if agent 1308 is a UE 115 and the output from model inference host 1304 is associated with routing or splitting of RLC PDUs, the agent 1308 may adjust parameters dynamically for processing (e.g., splitting) of RLC data PDUs based on output 1314.

Agent 1308 may indicate the one or more actions performed to at least one subject of action 1310. For example, if the agent 1308 adjust parameters dynamically for processing (e.g., splitting) of RLC data PDUs, the agent 1308 may output an indication to the subject of action 1310 (such as, one or more protocol layers of the UE 115).

As another example, agent 1308 may be a UE 115 and output 1314 from model inference host 1304 may include one or more characteristics for processing (e.g., splitting) of RLC data PDUs. For example, model inference host 1304 may predict threshold values for the splitting of RLC data PDUs based on congestion levels. Based on the predicted threshold values, agent 1308 may adjust parameters dynamically for processing (e.g., splitting) of RLC data PDUs and output the adjusted parameters to the subject of action 1310 (such as, one or more protocol layers of the UE 115 as described with reference to FIG. 12). In some cases, agent 1308 and the subject of action 1310 are the same entity.

Data can be collected from data sources 1306, and may be used as training data 1316 for training an ML model, or as inference data 1312 for feeding an ML model inference operation. Data sources 1306 may collect data from various subject of action 1310 entities (such as, the UE 115 or the network entity 105), and provide the collected data to a model training host 1302 for ML model training. For example, after a subject of action 1310 (such as, a UE 115) obtains congestion levels from agent 1308, the subject of action 1310 may provide performance feedback associated with the congestion levels to the data sources 1306. The performance feedback may be used by the model training host 1302 for monitoring or evaluating the ML model performance. In some examples, if output 1314 provided to agent 1308 is inaccurate (or the accuracy is below an accuracy threshold), model training host 1302 may provide feedback to model inference host 1304 to modify or retrain the ML model used by model inference host 1304, such as via an ML model deployment update.

Model training host 1302 may be deployed at the same or a different entity than that in which model inference host 13104 is deployed. For example, in order to offload model training processing, which can impact the performance of model inference host 1304, model training host 1302 may be deployed at a model server.

In some aspects, an ML model is deployed at or on a network entity (such as a base station 140 or a network entity 105) for supporting routing or splitting of RLC PDUs (e.g., selection of threshold values for the splitting). More specifically, a model interference host, such as model inference host 1304 in FIG. 13, may be deployed at or on the network entity 105 for such routing or splitting of RLC PDUs.

In some other aspects, an ML model is deployed at or on a UE (such as UE 115) for routing or splitting of RLC PDUs. More specifically, a model inference host, such as model inference host 1304 in FIG. 13, may be deployed at or on the UE for routing or splitting of RLC PDUs.

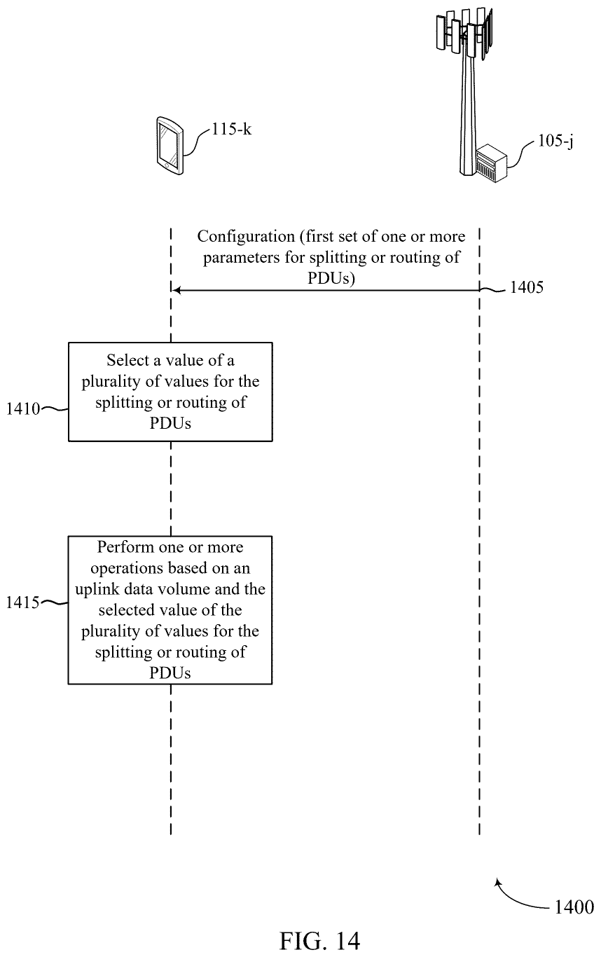

FIG. 14 shows an example of a process flow 1400 that supports AI-enabled routing and splitting of data traffic in accordance with one or more aspects of the present disclosure. The process flow 1400 may implement aspects of the wireless communications system 100 as described with reference to FIG. 1. The process flow 1400 may include a UE 115-k and a network entity 105-j, which may be examples of UEs 115 and network entities 105 as described herein. In the following description of the process flow 1400, the operations between the UE 115-k and the network entity 105-j may be transmitted in a different order than the example order shown, or the operations performed by the UE 115-k and the network entity 105-j may be performed in different orders or at different times. Some operations may also be omitted from the process flow 1400, and other operations may be added to the process flow 1400.

At 1405, the network entity 105-j may transmit, and the UE 115-k may receive, control signaling that indicates a configuration including a first set of one or more parameters for one or more of splitting or routing a set of PDUs by a PDCP entity of the UE 115-k to one or more of a first RLC entity or a second RLC entity. At least one parameter (e.g., a data volume threshold, ul-DataSplitThreshold) of the first set of one or more parameters may be associated with a plurality of values (e.g., a range of values), a plurality of performance metrics, or a combination thereof. At 1410, the UE 115-k may select a value of the plurality of values for the at least one parameter (e.g., data volume threshold) for one or more of splitting or routing the set of PDUs based on a second set of one or more parameters as described herein with reference to FIG. 11. The second set of parameters may include a HARQ failure rate, an RLC failure rate, or a latency over one or more RLC entities, and the selection by the UE 115-k of the value (e.g., data volume threshold) may be based on the HARQ failure rate, the RLC failure rate, the latency over the one or more RLC entities, or a combination thereof satisfying one or more thresholds.

At 1415, the UE 115-k may process the set of PDUs by one or more of splitting or routing one or more PDUs of the set of PDUs to one or more of the first RLC entity or the second RLC entity of the UE 115-k based at least in part on an uplink data volume at the PDCP entity, the first RLC entity, and the second RLC entity (e.g., a total data volume of L2 at the UE 115-k) and according to the selected value of the plurality of values for the at least one parameter (e.g., data volume threshold).

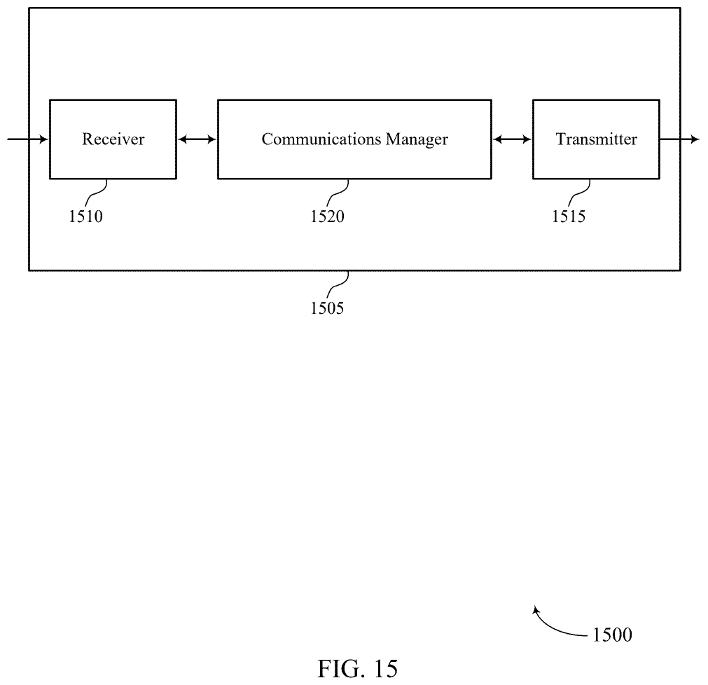

FIG. 15 shows a block diagram 1500 of a device 1505 that supports AI-enabled routing and splitting of data traffic in accordance with one or more aspects of the present disclosure. The device 1505 may be an example of aspects of a UE 115 as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to, individually or collectively, support or enable the described techniques. Each of these components may be in communication with one another (e.g., via one or more buses).

The receiver 1510 may provide a means for receiving information such as packets, user data, control information, or any combination thereof associated with various information channels (e.g., control channels, data channels, information channels related to AI-enabled routing and splitting of data traffic). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to AI-enabled routing and splitting of data traffic). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations or components thereof may be examples of means for performing various aspects of AI-enabled routing and splitting of data traffic as described herein. For example, the communications manager 1520, the receiver 1510, the transmitter 1515, or various combinations or components thereof may be capable of performing one or more of the functions described herein.

In some examples, the communications manager 1520, the receiver 1510, the transmitter 1515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1520, the receiver 1510, the transmitter 1515, or various combinations or components thereof may be implemented in code (e.g., as communications management software or firmware) executed by at least one processor (e.g., referred to as a processor-executable code). If implemented in code executed by at least one processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications in accordance with examples as disclosed herein. For example, the communications manager 1520 is capable of, configured to, or operable to support a means for receiving control signaling that indicates a configuration including a first set of one or more parameters for one or more of splitting or routing a set of PDUs by a PDCP entity of the wireless device to one or more of a first RLC entity or a second RLC entity of the wireless device, where at least one parameter of the first set of one or more parameters is associated with a set of multiple values, a set of multiple performance metrics, or a combination thereof. The communications manager 1520 is capable of, configured to, or operable to support a means for selecting a value of the set of multiple values for the at least one parameter, for one or more of splitting or routing the set of PDUs, based on a second set of one or more parameters, where the selected value corresponds to an uplink data volume threshold. The communications manager 1520 is capable of, configured to, or operable to support a means for processing the set of PDUs, by one or more of splitting or routing one or more PDUs of the set of PDUs to one or more of the first RLC entity or the second RLC entity of the wireless device, based on an uplink data volume associated with one or more of the PDCP entity, the first RLC entity, or the second RLC entity and according to the selected value.

By including or configuring the communications manager 1520 in accordance with examples as described herein, the device 1505 (e.g., at least one processor controlling or otherwise coupled with the receiver 1510, the transmitter 1515, the communications manager 1520, or a combination thereof) may support techniques for reduced processing, reduced power consumption, and more efficient utilization of communication resources.

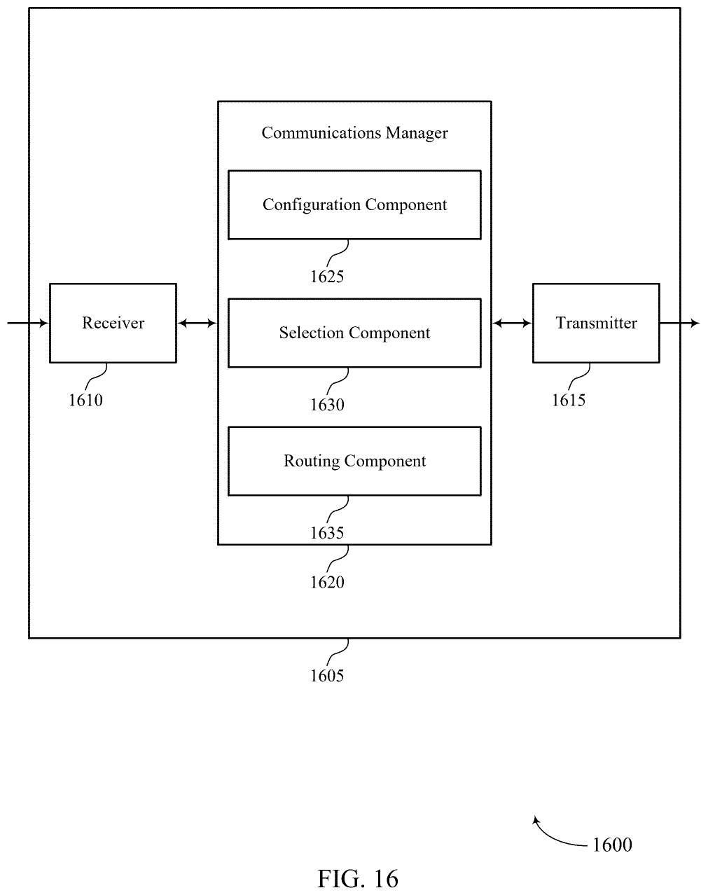

FIG. 16 shows a block diagram 1600 of a device 1605 that supports AI-enabled routing and splitting of data traffic in accordance with one or more aspects of the present disclosure. The device 1605 may be an example of aspects of a device 1505 or a UE 116 as described herein. The device 1605 may include a receiver 1610, a transmitter 1616, and a communications manager 1620. The device 1605, or one or more components of the device 1605 (e.g., the receiver 1610, the transmitter 1615, the communications manager 1620), may include at least one processor, which may be coupled with at least one memory, to support the described techniques. Each of these components may be in communication with one another (e.g., via one or more buses).

The receiver 1610 may provide a means for receiving information such as packets, user data, control information, or any combination thereof associated with various information channels (e.g., control channels, data channels, information channels related to AI-enabled routing and splitting of data traffic). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to AI-enabled routing and splitting of data traffic). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of AI-enabled routing and splitting of data traffic as described herein. For example, the communications manager 1620 may include a configuration component 1625, a selection component 1630, a routing component 1635, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications in accordance with examples as disclosed herein. The configuration component 1625 is capable of, configured to, or operable to support a means for receiving control signaling that indicates a configuration including a first set of one or more parameters for one or more of splitting or routing a set of PDUs by a PDCP entity of the wireless device to one or more of a first RLC entity or a second RLC entity of the wireless device, where at least one parameter of the first set of one or more parameters is associated with a set of multiple values, a set of multiple performance metrics, or a combination thereof. The selection component 1630 is capable of, configured to, or operable to support a means for selecting a value of the set of multiple values for the at least one parameter, for one or more of splitting or routing the set of PDUs, based on a second set of one or more parameters, where the selected value corresponds to an uplink data volume threshold. The routing component 1635 is capable of, configured to, or operable to support a means for processing the set of PDUs, by one or more of splitting or routing one or more PDUs of the set of PDUs to one or more of the first RLC entity or the second RLC entity of the wireless device, based on an uplink data volume associated with one or more of the PDCP entity, the first RLC entity, or the second RLC entity and according to the selected value.

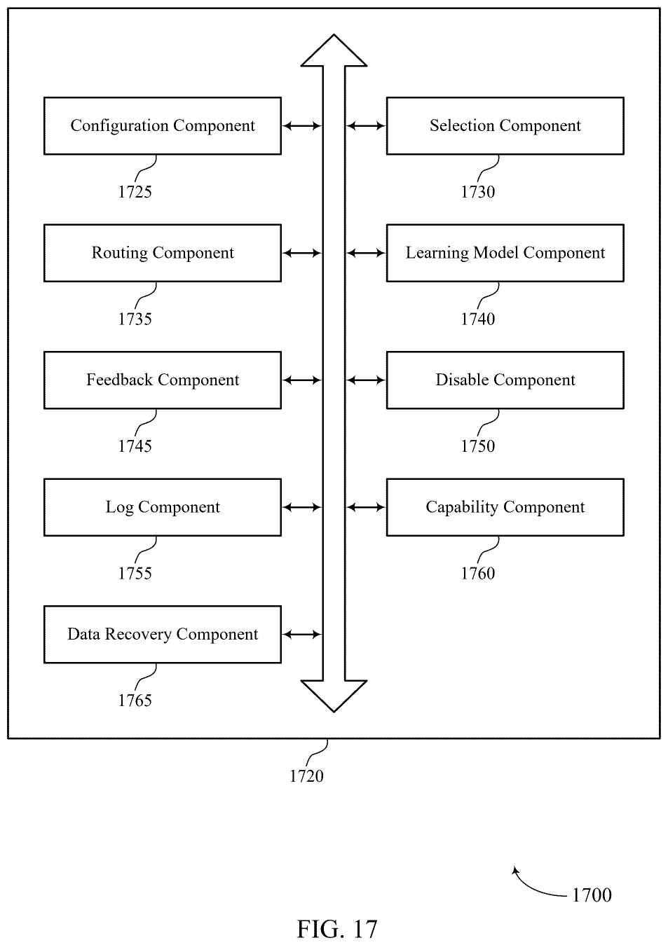

FIG. 17 shows a block diagram 1700 of a communications manager 1720 that supports AI-enabled routing and splitting of data traffic in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of AI-enabled routing and splitting of data traffic as described herein. For example, the communications manager 1720 may include a configuration component 1725, a selection component 1730, a routing component 1735, a learning model component 1740, a feedback component 1745, a disable component 1750, a log component 1755, a capability component 1760, a data recovery component 1765, or any combination thereof. Each of these components, or components or subcomponents thereof (e.g., one or more processors, one or more memories), may communicate, directly or indirectly, with one another (e.g., via one or more buses).

The communications manager 1720 may support wireless communications in accordance with examples as disclosed herein. The configuration component 1725 is capable of, configured to, or operable to support a means for receiving control signaling that indicates a configuration including a first set of one or more parameters for one or more of splitting or routing a set of PDUs by a PDCP entity of the wireless device to one or more of a first RLC entity or a second RLC entity of the wireless device, where at least one parameter of the first set of one or more parameters is associated with a set of multiple values, a set of multiple performance metrics, or a combination thereof. The selection component 1730 is capable of, configured to, or operable to support a means for selecting a value of the set of multiple values for the at least one parameter, for one or more of splitting or routing the set of PDUs, based on a second set of one or more parameters, where the selected value corresponds to an uplink data volume threshold. The routing component 1735 is capable of, configured to, or operable to support a means for processing the set of PDUs, by one or more of splitting or routing one or more PDUs of the set of PDUs to one or more of the first RLC entity or the second RLC entity of the wireless device, based on an uplink data volume associated with one or more of the PDCP entity, the first RLC entity, or the second RLC entity and according to the selected value.

In some examples, the learning model component 1740 is capable of, configured to, or operable to support a means for obtaining the value from a learning model associated with the PDCP entity of the wireless device, where an input to the learning model includes one or more of the first set of one or more parameters or the second set of one or more parameters, where the value includes an output of the learning model, where the value is selected based on the output of the learning model.

In some examples, the second set of one or more parameters includes one or more of at least one first parameter that indicates a first performance associated with an HARQ process for one or more of the first RLC entity of the wireless device or the second RLC entity of the wireless device, or at least one second parameter that indicates a second performance associated with a RLC process for one or more of the first RLC entity of the wireless device or the second RLC entity of the wireless device.

In some examples, the feedback component 1745 is capable of, configured to, or operable to support a means for transmitting, to a second wireless device, a RRC message including an indication of the selected value. In some examples, the feedback component 1745 is capable of, configured to, or operable to support a means for transmitting, to the second wireless device, a MAC-CE including the indication of the selected value, where the second wireless device include a UE or a network entity, where the network entity includes a base station or a server associated with a learning model.

In some examples, the configuration component 1725 is capable of, configured to, or operable to support a means for receiving, from the second wireless device, an indication of a second value of the set of multiple values for the at least one parameter, where processing the set of PDUs, by one or more of splitting or routing one or more PDUs of the set of PDUs to one or more of the first RLC entity or the second RLC entity of the wireless device, is based on the uplink data volume associated with one or more of the PDCP entity, the first RLC entity, or the second RLC entity and according to the second value of the set of multiple values for the at least one parameter.

In some examples, the feedback component 1745 is capable of, configured to, or operable to support a means for generating at least one PDU including an indication of the selected value. In some examples, the feedback component 1745 is capable of, configured to, or operable to support a means for outputting, to a second wireless device via the PDCP entity of the wireless device, the at least one PDU including the indication of the selected value, where the at least one PDU includes a PDCP data PDU or a PDCP control PDU, and where the second wireless device include a UE or a network entity, where the network entity includes a base station or a server associated with a learning model.

In some examples, the feedback component 1745 is capable of, configured to, or operable to support a means for receiving, from a second wireless device, an indication of at least one acknowledgment or negative acknowledgment associated with the selected value, where the second wireless device includes a UE or a network entity, where the network entity includes a base station or a server associated with a learning model.

In some examples, the routing component 1735 is capable of, configured to, or operable to support a means for processing, based on the configuration and an availability of one or more resources in a grant associated with the second RLC entity, the set of PDUs, by one or more of splitting or routing the one or more PDUs of the set of PDUs to one or more of the first RLC entity or the second RLC entity of the wireless device irrespective of the uplink data volume threshold and the uplink data volume associated with the second RLC entity.

In some examples, the disable component 1750 is capable of, configured to, or operable to support a means for determining whether to disable the first RLC entity or the second RLC entity of the wireless device for a duration according to a learning model associated with the PDCP entity of the wireless device, where an input to the learning model includes one or more of the first set of one or more parameters or the second set of one or more parameters. In some examples, the disable component 1750 is capable of, configured to, or operable to support a means for disabling the first RLC entity or the second RLC entity of the wireless device for the duration based on the determining, where an output of the learning model indicates to disable the first RLC entity or the second RLC entity of the wireless device.

In some examples, the data recovery component 1765 is capable of, configured to, or operable to support a means for performing a PDU recovery procedure by routing at least one PDU of the set of PDUs from the first RLC entity to the second RLC entity of the wireless device based on disabling the first RLC entity of the wireless device.

In some examples, the routing component 1735 is capable of, configured to, or operable to support a means for switching from the first RLC entity as a primary RLC path to the second RLC entity as the primary RLC path for the set of PDUs. In some examples, the routing component 1735 is capable of, configured to, or operable to support a means for switching from the second RLC entity as the primary RLC path to the first RLC entity as the primary RLC path for the set of PDUs.

In some examples, a third set of one or more parameters include an output of a learning model associated with the PDCP entity of the wireless device. In some examples, the third set of one or more parameters is based on a first channel quality indicator threshold value associated with the first RLC entity of the wireless device, a second channel quality indicator threshold value associated with the second RLC entity of the wireless device, or both.

In some examples, the log component 1755 is capable of, configured to, or operable to support a means for storing a set of one or more logs associated with a learning model, where at least one first log of the set of one or more logs includes a set of previous selected values of the set of multiple values for the at least one parameter, where at least one second log of the set of one or more logs includes a third set of one or more parameters associated with one or more of the first RLC entity or the second RLC entity of the wireless device, the third set of one or more parameters including one or more of a channel quality indicator or a reference signal received power, where at least one third log of the set of one or more logs includes a fourth set of one or more parameters associated one or more of the first RLC entity or the second RLC entity of the wireless device, the fourth set of one or more parameters including one or more of a channel quality indicator threshold value or a reference signal received power threshold value, where at least one fourth log of set of one or more logs includes a fifth set of one or more parameters including at least one parameter that indicates an end-to-end (E2E) delay associated with one or more of the first RLC entity or the second RLC entity of the wireless device, and where at least one fifth log of set of one or more logs includes an indication of one or more recovery procedures performed by the wireless device and associated with one or more of the first RLC entity or the second RLC entity of the wireless device. In some examples, the learning model component 1740 is capable of, configured to, or operable to support a means for transmitting, to a second wireless device, a report including the set of one or more logs associated with the learning model.

In some examples, the capability component 1760 is capable of, configured to, or operable to support a means for transmitting, to a second wireless device, a report including capability information that indicates whether the wireless device supports a learning model associated with one or more of splitting or routing the set of PDUs, where the capability information further indicates whether the wireless device supports one or more of predicting latency associated with one or more of the first RLC entity or the second RLC entity of the wireless device, or reporting of an accuracy of the learning model, where receiving the control signaling is based on the capability information.

In some examples, the first set of one or more parameters includes one or more of at least one first parameter that indicates a first threshold value for the uplink data volume, at least one second parameter that indicates a second threshold value for the uplink data volume, at least one third parameter that indicates a threshold quantity of grants allowed to be missed at the wireless device for the first RLC entity, at least one fourth parameter that indicates whether the wireless device is configured to disable at least one of the first RLC entity or the second RLC entity, at least one fifth parameter that indicates whether data recovery is configured in response to at least one of the first RLC entity or the second RLC entity being disabled, at least one sixth parameter that indicates a first threshold duration for disabling at least one of the first RLC entity or the second RLC entity, at least one seventh parameter that indicates a second threshold duration to be satisfied prior to disabling at least one of the first RLC entity or the second RLC entity, at least one eighth parameter that indicates whether primary path switching is allowed for at least one of the first RLC entity or the second RLC entity, at least one nineth parameter that indicates a CQI threshold value to be satisfied prior to disabling at least one of the first RLC entity or the second RLC entity, at least one tenth parameter that indicates whether a learning model is enabled or disabled, or at least one eleventh parameter that indicates whether the learning model is enabled or disabled for a Quality-of-Service (QOS) flow associated with the set of PDUs.

In some examples, the second set of one or more parameters includes one or more of at least one first parameter that indicates a first criterion associated with an order of transmission or reception of the set of PDUs, at least one second parameter that indicates a second criterion associated with retransmission of one or more PDUs of the set of PDUs, at least one third parameter that indicates a third criterion associated with a latency of transmission, reception, or retransmission of one or more PDUs of the set of PDUs, or at least one fourth parameter that indicates a fourth criterion associated with a reordering window for one or more PDUs of the set of PDUs.

In some examples, the learning model component 1740 is capable of, configured to, or operable to support a means for receiving, from a second wireless device, a report that indicates a performance associated with one or more of the first set of one or more parameters or the second set of one or more parameters for one or more of splitting or routing the set of PDUs by the PDCP entity of the wireless device to one or more of the first RLC entity or the second RLC entity of the wireless device.

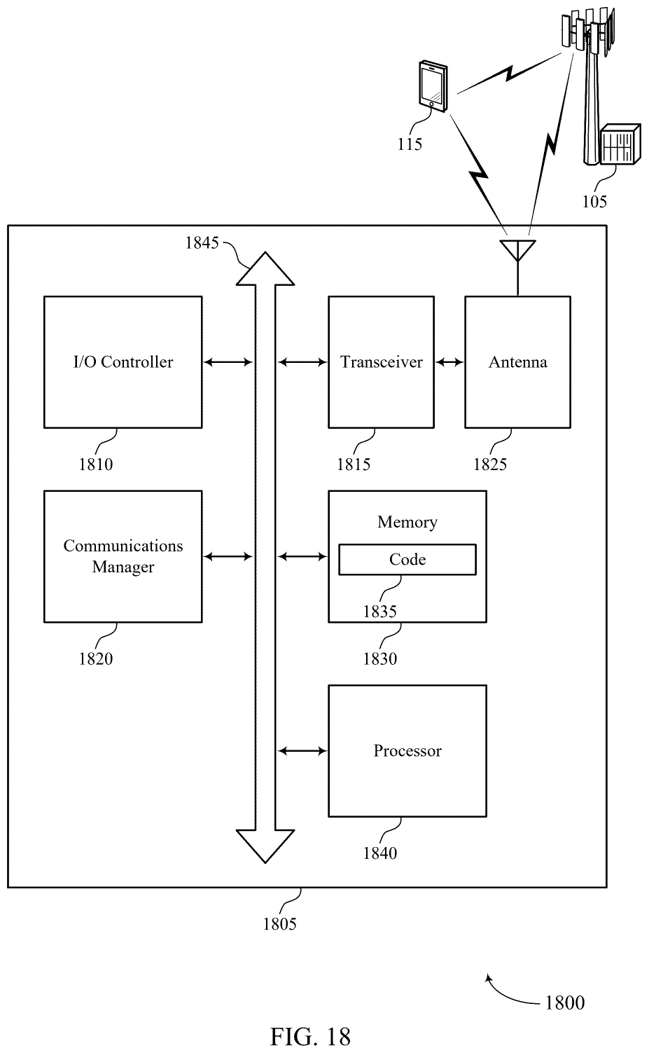

FIG. 18 shows a diagram of a system 1800 including a device 1805 that supports AI-enabled routing and splitting of data traffic in accordance with one or more aspects of the present disclosure. The device 1805 may be an example of or include components of a device 1505, a device 1505, or a UE 115 as described herein. The device 1805 may communicate (e.g., wirelessly) with one or more other devices (e.g., network entities 105, UEs 115, or a combination thereof). The device 1805 may include components for bi-directional voice and data communications including components for transmitting and receiving communications, such as a communications manager 1820, an input/output (I/O) controller, such as an I/O controller 1810, a transceiver 1815, one or more antennas 1825, at least one memory 1830, code 1835, and at least one processor 1840. These components may be in electronic communication or otherwise coupled (e.g., operatively, communicatively, functionally, electronically, electrically) via one or more buses (e.g., a bus 1845).

The I/O controller 1810 may manage input and output signals for the device 1805. The I/O controller 1810 may also manage peripherals not integrated into the device 1805. In some cases, the I/O controller 1810 may represent a physical connection or port to an external peripheral. In some cases, the I/O controller 1810 may utilize an operating system such as iOS®, ANDROID®, MS-DOS®, MS-WINDOWS®, OS/2®, UNIX®, LINUX®, or another known operating system. Additionally, or alternatively, the I/O controller 1810 may represent or interact with a modem, a keyboard, a mouse, a touchscreen, or a similar device. In some cases, the I/O controller 1810 may be implemented as part of one or more processors, such as the at least one processor 1840. In some cases, a user may interact with the device 1805 via the I/O controller 1810 or via hardware components controlled by the I/O controller 1810.

In some cases, the device 1805 may include a single antenna. However, in some other cases, the device 1805 may have more than one antenna, which may be capable of concurrently transmitting or receiving multiple wireless transmissions. The transceiver 1815 may communicate bi-directionally via the one or more antennas 1825 using wired or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1515, a receiver 1510, a receiver 1510, or any combination thereof or component thereof, as described herein.

The at least one memory 1830 may include random access memory (RAM) and read-only memory (ROM). The at least one memory 1830 may store computer-readable, computer-executable, or processor-executable code, such as the code 1835. The code 1835 may include instructions that, when executed by the at least one processor 1840, cause the device 1805 to perform various functions described herein. The code 1835 may be stored in a non-transitory computer-readable medium such as system memory or another type of memory. In some cases, the code 1835 may not be directly executable by the at least one processor 1840 but may cause a computer (e.g., when compiled and executed) to perform functions described herein. In some cases, the at least one memory 1830 may include, among other things, a basic I/O system (BIOS) which may control basic hardware or software operation such as the interaction with peripheral components or devices.

The at least one processor 1840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1840 may be configured to operate a memory array using a memory controller. In some other cases, a memory controller may be integrated into the at least one processor 1840. The at least one processor 1840 may be configured to execute computer-readable instructions stored in a memory (e.g., the at least one memory 1830) to cause the device 1805 to perform various functions (e.g., functions or tasks supporting AI-enabled routing and splitting of data traffic). For example, the device 1805 or a component of the device 1805 may include at least one processor 1840 and at least one memory 1830 coupled with or to the at least one processor 1840, the at least one processor 1840 and the at least one memory 1830 configured to perform various functions described herein.

In some examples, the at least one processor 1840 may include multiple processors and the at least one memory 1830 may include multiple memories. One or more of the multiple processors may be coupled with one or more of the multiple memories, which may, individually or collectively, be configured to perform various functions described herein. In some examples, the at least one processor 1840 may be a component of a processing system, which may refer to a system (such as a series) of machines, circuitry (including, for example, one or both of processor circuitry (which may include the at least one processor 1840) and memory circuitry (which may include the at least one memory 1830)), or components, that receives or obtains inputs and processes the inputs to produce, generate, or obtain a set of outputs. The processing system may be configured to perform one or more of the functions described herein. For example, the at least one processor 1840 or a processing system including the at least one processor 1840 may be configured to, configurable to, or operable to cause the device 1805 to perform one or more of the functions described herein. Further, as described herein, being “configured to,” being “configurable to,” and being “operable to” may be used interchangeably and may be associated with a capability, when executing code 1835 (e.g., processor-executable code) stored in the at least one memory 1830 or otherwise, to perform one or more of the functions described herein.

The communications manager 1820 may support wireless communications in accordance with examples as disclosed herein. For example, the communications manager 1820 is capable of, configured to, or operable to support a means for receiving control signaling that indicates a configuration including a first set of one or more parameters for one or more of splitting or routing a set of PDUs by a PDCP entity of the wireless device to one or more of a first RLC entity or a second RLC entity of the wireless device, where at least one parameter of the first set of one or more parameters is associated with a set of multiple values, a set of multiple performance metrics, or a combination thereof. The communications manager 1820 is capable of, configured to, or operable to support a means for selecting a value of the set of multiple values for the at least one parameter, for one or more of splitting or routing the set of PDUs, based on a second set of one or more parameters, where the selected value corresponds to an uplink data volume threshold. The communications manager 1820 is capable of, configured to, or operable to support a means for processing the set of PDUs, by one or more of splitting or routing one or more PDUs of the set of PDUs to one or more of the first RLC entity or the second RLC entity of the wireless device, based on an uplink data volume associated with one or more of the PDCP entity, the first RLC entity, or the second RLC entity and according to the selected value.

By including or configuring the communications manager 1820 in accordance with examples as described herein, the device 1805 may support techniques for reduced latency, improved user experience related to reduced processing, reduced power consumption, and more efficient utilization of communication resources.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the at least one processor 1840, the at least one memory 1830, the code 1835, or any combination thereof. For example, the code 1835 may include instructions executable by the at least one processor 1840 to cause the device 1805 to perform various aspects of AI-enabled routing and splitting of data traffic as described herein, or the at least one processor 1840 and the at least one memory 1830 may be otherwise configured to, individually or collectively, perform or support such operations.

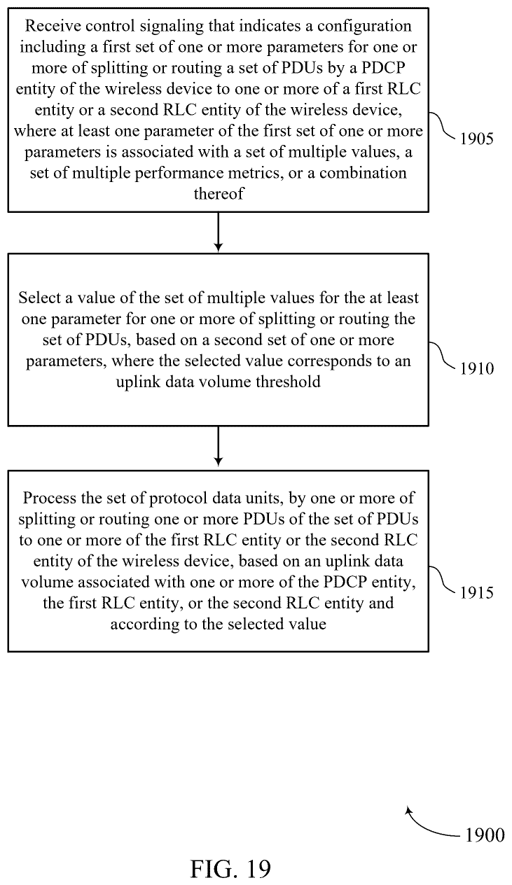

FIG. 19 shows a flowchart illustrating a method 1900 that supports AI-enabled routing and splitting of data traffic in accordance with one or more aspects of the present disclosure. The operations of the method 1900 may be implemented by a UE or its components as described herein. For example, the operations of the method 1900 may be performed by a UE 115 as described with reference to FIGS. 1 through 18. In some examples, a UE may execute a set of instructions to control the functional elements of the UE to perform the described functions. Additionally, or alternatively, the UE may perform aspects of the described functions using special-purpose hardware.

At 1905, the method may include receiving control signaling that indicates a configuration including a first set of one or more parameters for one or more of splitting or routing a set of PDUs by a PDCP entity of the wireless device to one or more of a first RLC entity or a second RLC entity of the wireless device, where at least one parameter of the first set of one or more parameters is associated with a set of multiple values, a set of multiple performance metrics, or a combination thereof. The operations of 1905 may be performed in accordance with examples as disclosed herein. In some examples, aspects of the operations of 1905 may be performed by a configuration component 1725 as described with reference to FIG. 17.

At 1910, the method may include selecting a value of the set of multiple values for the at least one parameter, for one or more of splitting or routing the set of PDUs, based on a second set of one or more parameters, where the selected value corresponds to an uplink data volume threshold. The operations of 1910 may be performed in accordance with examples as disclosed herein. In some examples, aspects of the operations of 1910 may be performed by a selection component 1730 as described with reference to FIG. 17.

At 1915, the method may include processing the set of PDUs, by one or more of splitting or routing one or more PDUs of the set of PDUs to one or more of the first RLC entity or the second RLC entity of the wireless device, based on an uplink data volume associated with one or more of the PDCP entity, the first RLC entity, or the second RLC entity and according to the selected value. The operations of 1915 may be performed in accordance with examples as disclosed herein. In some examples, aspects of the operations of 1915 may be performed by a routing component 1735 as described with reference to FIG. 17.

Aspect 1: A method for wireless communications at a wireless device, comprising: receiving control signaling that indicates a configuration comprising a first set of one or more parameters for one or more of splitting or routing a set of PDUs by a PDCP entity of the wireless device to one or more of a first RLC entity or a second RLC entity of the wireless device, wherein at least one parameter of the first set of one or more parameters is associated with a plurality of values, a plurality of performance metrics, or a combination thereof; selecting a value of the plurality of values for the at least one parameter, for one or more of splitting or routing the set of PDUs, based at least in part on a second set of one or more parameters, wherein the selected value corresponds to an uplink data volume threshold; and processing the set of PDUs, by one or more of splitting or routing one or more PDUs of the set of PDUs to one or more of the first RLC entity or the second RLC entity of the wireless device, based at least in part on an uplink data volume associated with one or more of the PDCP entity, the first RLC entity, or the second RLC entity and according to the selected value.

Aspect 2: The method of aspect 1, further comprising: obtaining the value from a learning model associated with the PDCP entity of the wireless device, wherein an input to the learning model comprises one or more of the first set of one or more parameters or the second set of one or more parameters, wherein the value comprises an output of the learning model, wherein the value is selected based at least in part on the output of the learning model.

Aspect 3: The method of aspect 2, wherein the second set of one or more parameters comprises one or more of at least one first parameter that indicates a first performance associated with an HARQ process for one or more of the first RLC entity of the wireless device or the second RLC entity of the wireless device, or at least one second parameter that indicates a second performance associated with a RLC process for one or more of the first RLC entity of the wireless device or the second RLC entity of the wireless device.

Aspect 4: The method of any of aspects 1 through 3, further comprising: transmitting, to a second wireless device, a RRC message comprising an indication of the selected value; or transmitting, to the second wireless device, a MAC-CE comprising the indication of the selected value, wherein the second wireless device comprise a UE or a network entity, wherein the network entity includes a base station or a server associated with a learning model.

Aspect 5: The method of aspect 4, further comprising: receiving, from the second wireless device, an indication of a second value of the plurality of values for the at least one parameter, wherein processing the set of PDUs, by one or more of splitting or routing one or more PDUs of the set of PDUs to one or more of the first RLC entity or the second RLC entity of the wireless device, is based at least in part on the uplink data volume associated with one or more of the PDCP entity, the first RLC entity, or the second RLC entity and according to the second value of the plurality of values for the at least one parameter.

Aspect 6: The method of any of aspects 1 through 5, further comprising: generating at least one PDU comprising an indication of the selected value; and outputting, to a second wireless device via the PDCP entity of the wireless device, the at least one PDU comprising the indication of the selected value, wherein the at least one PDU comprises a PDCP data PDU or a PDCP control PDU, and wherein the second wireless device comprise a UE or a network entity, wherein the network entity includes a base station or a server associated with a learning model.

Aspect 7: The method of any of aspects 1 through 6, further comprising: receiving, from a second wireless device, an indication of at least one acknowledgment or negative acknowledgment associated with the selected value, wherein the second wireless device comprises a UE or a network entity, wherein the network entity includes a base station or a server associated with a learning model.

Aspect 8: The method of any of aspects 1 through 7, further comprising: processing, based at least in part on the configuration and an availability of one or more resources in a grant associated with the second RLC entity, the set of PDUs, by one or more of splitting or routing the one or more PDUs of the set of PDUs to one or more of the first RLC entity or the second RLC entity of the wireless device irrespective of the uplink data volume threshold and the uplink data volume associated with the second RLC entity.

Aspect 9: The method of any of aspects 1 through 8, further comprising: determining whether to disable the first RLC entity or the second RLC entity of the wireless device for a duration according to a learning model associated with the PDCP entity of the wireless device, wherein an input to the learning model comprises one or more of the first set of one or more parameters or the second set of one or more parameters; and disabling the first RLC entity or the second RLC entity of the wireless device for the duration based at least in part on the determining, wherein an output of the learning model indicates to disable the first RLC entity or the second RLC entity of the wireless device.

Aspect 10: The method of aspect 9, further comprising: performing a PDU recovery procedure by routing at least one PDU of the set of PDUs from the first RLC entity to the second RLC entity of the wireless device based at least in part on disabling the first RLC entity of the wireless device.

Aspect 11: The method of any of aspects 1 through 10, further comprising: switching from the first RLC entity as a primary RLC path to the second RLC entity as the primary RLC path for the set of PDUs; or switching from the second RLC entity as the primary RLC path to the first RLC entity as the primary RLC path for the set of PDUs.

Aspect 12: The method of any of aspects 1 through 11, wherein a third set of one or more parameters comprise an output of a learning model associated with the PDCP entity of the wireless device, the third set of one or more parameters is based at least in part on a first channel quality indicator threshold value associated with the first RLC entity of the wireless device, a second channel quality indicator threshold value associated with the second RLC entity of the wireless device, or both.

Aspect 13: The method of any of aspects 1 through 12, further comprising: storing a set of one or more logs associated with a learning model, wherein at least one first log of the set of one or more logs comprises a set of previous selected values of the plurality of values for the at least one parameter, wherein at least one second log of the set of one or more logs comprises a third set of one or more parameters associated with one or more of the first RLC entity or the second RLC entity of the wireless device, the third set of one or more parameters comprising one or more of a channel quality indicator or a reference signal received power, wherein at least one third log of the set of one or more logs comprises a fourth set of one or more parameters associated one or more of the first RLC entity or the second RLC entity of the wireless device, the fourth set of one or more parameters comprising one or more of a channel quality indicator threshold value or a reference signal received power threshold value, wherein at least one fourth log of set of one or more logs comprises a fifth set of one or more parameters comprising at least one parameter that indicates an end-to-end (E2E) delay associated with one or more of the first RLC entity or the second RLC entity of the wireless device, and wherein at least one fifth log of set of one or more logs comprises an indication of one or more recovery procedures performed by the wireless device and associated with one or more of the first RLC entity or the second RLC entity of the wireless device; and transmitting, to a second wireless device, a report comprising the set of one or more logs associated with the learning model.

Aspect 14: The method of any of aspects 1 through 13, further comprising: transmitting, to a second wireless device, a report comprising capability information that indicates whether the wireless device supports a learning model associated with one or more of splitting or routing the set of PDUs, wherein the capability information further indicates whether the wireless device supports one or more of predicting latency associated with one or more of the first RLC entity or the second RLC entity of the wireless device, or reporting of an accuracy of the learning model, wherein receiving the control signaling is based at least in part on the capability information.

Aspect 15: The method of any of aspects 1 through 14, wherein the first set of one or more parameters comprises one or more of at least one first parameter that indicates a first threshold value for the uplink data volume, at least one second parameter that indicates a second threshold value for the uplink data volume, at least one third parameter that indicates a threshold quantity of grants allowed to be missed at the wireless device to miss for the first RLC entity, at least one fourth parameter that indicates whether the wireless device is configured to disable at least one of the first RLC entity or the second RLC entity, at least one fifth parameter that indicates whether data recovery is configured in response to at least one of the first RLC entity or the second RLC entity being disabled, at least one sixth parameter that indicates a first threshold duration for disabling at least one of the first RLC entity or the second RLC entity, at least one seventh parameter that indicates a second threshold duration to be satisfied prior to disabling at least one of the first RLC entity or the second RLC entity, at least one eighth parameter that indicates whether primary path switching is allowed for at least one of the first RLC entity or the second RLC entity, at least one nineth parameter that indicates a CQI threshold value to be satisfied prior to disabling at least one of the first RLC entity or the second RLC entity, at least one tenth parameter that indicates whether a learning model is enabled or disabled, or at least one eleventh parameter that indicates whether the learning model is enabled or disabled for a QoS flow associated with the set of PDUs.

Aspect 16: The method of any of aspects 1 through 15, wherein the second set of one or more parameters comprises one or more of at least one first parameter that indicates a first criterion associated with an order of transmission or reception of the set of PDUs, at least one second parameter that indicates a second criterion associated with retransmission of one or more PDUs of the set of PDUs, at least one third parameter that indicates a third criterion associated with a latency of transmission, reception, or retransmission of one or more PDUs of the set of PDUs, or at least one fourth parameter that indicates a fourth criterion associated with a reordering window for one or more PDUs of the set of PDUs.

Aspect 17: The method of any of aspects 1 through 16, further comprising: receiving, from a second wireless device, a report that indicates a performance associated with one or more of the first set of one or more parameters or the second set of one or more parameters for one or more of splitting or routing the set of PDUs by the PDCP entity of the wireless device to one or more of the first RLC entity or the second RLC entity of the wireless device.

Aspect 18: A wireless device for wireless communications, comprising one or more memories storing processor-executable code, and one or more processors coupled with the one or more memories and individually or collectively operable to execute the code to cause the wireless device to perform a method of any of aspects 1 through 17.

Aspect 19: A wireless device for wireless communications, comprising at least one means for performing a method of any of aspects 1 through 17.

Aspect 20: A non-transitory computer-readable medium storing code for wireless communications, the code comprising instructions executable by one or more processors to perform a method of any of aspects 1 through 17.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
receive control signaling that indicates a configuration comprising a first set of one or more parameters for one or more of splitting or routing a set of protocol data units by a packet data convergence protocol entity of the wireless device to one or more of a first radio link control entity or a second radio link control entity of the wireless device, wherein at least one parameter of the first set of one or more parameters is associated with a plurality of values, a plurality of performance metrics, or a combination thereof;
select a value of the plurality of values for the at least one parameter, for one or more of splitting or routing the set of protocol data units, based at least in part on a second set of one or more parameters, wherein the selected value corresponds to an uplink data volume threshold; and
process the set of protocol data units, by one or more of splitting or routing one or more protocol data units of the set of protocol data units to one or more of the first radio link control entity or the second radio link control entity of the wireless device, based at least in part on an uplink data volume associated with one or more of the packet data convergence protocol entity, the first radio link control entity, or the second radio link control entity and according to the selected value.

2. The wireless device of claim 1, wherein the one or more processors are individually or collectively further operable to execute the code to cause the wireless device to:
obtain the value from a learning model associated with the packet data convergence protocol entity of the wireless device, wherein an input to the learning model comprises one or more of the first set of one or more parameters or the second set of one or more parameters, wherein the value comprises an output of the learning model,
wherein the value is selected based at least in part on the output of the learning model.

3. The wireless device of claim 2, wherein the second set of one or more parameters comprises one or more of at least one first parameter that indicates a first performance associated with a hybrid automatic repeat request (HARQ) process for one or more of the first radio link control entity of the wireless device or the second radio link control entity of the wireless device, or at least one second parameter that indicates a second performance associated with a radio link control process for one or more of the first radio link control entity of the wireless device or the second radio link control entity of the wireless device.

4. The wireless device of claim 1, wherein the one or more processors are individually or collectively further operable to execute the code to cause the wireless device to:
transmit, to a second wireless device, a radio resource control message comprising an indication of the selected value; or
transmit, to the second wireless device, a medium access control-control element comprising the indication of the selected value,
wherein the second wireless device comprise a user equipment (UE) or a network entity, wherein the network entity includes a base station or a server associated with a learning model.

5. The wireless device of claim 4, wherein the one or more processors are individually or collectively further operable to execute the code to cause the wireless device to:
receive, from the second wireless device, an indication of a second value of the plurality of values for the at least one parameter,
wherein processing the set of protocol data units, by one or more of splitting or routing the one or more protocol data units of the set of protocol data units to one or more of the first radio link control entity or the second radio link control entity of the wireless device, is based at least in part on the uplink data volume associated with one or more of the packet data convergence protocol entity, the first radio link control entity, or the second radio link control entity and according to the second value of the plurality of values for the at least one parameter.

6. The wireless device of claim 1, wherein the one or more processors are individually or collectively further operable to execute the code to cause the wireless device to:
generate at least one protocol data unit comprising an indication of the selected value; and
output, to a second wireless device via the packet data convergence protocol entity of the wireless device, the at least one protocol data unit comprising the indication of the selected value,
wherein the at least one protocol data unit comprises a packet data convergence protocol data protocol data unit or a packet data convergence protocol control protocol data unit, and wherein the second wireless device comprises a user equipment (UE) or a network entity, wherein the network entity includes a base station or a server associated with a learning model.

7. The wireless device of claim 1, wherein the one or more processors are individually or collectively further operable to execute the code to cause the wireless device to:
receive, from a second wireless device, an indication of at least one acknowledgment or negative acknowledgment associated with the selected value, wherein the second wireless device comprises a user equipment (UE) or a network entity, wherein the network entity includes a base station or a server associated with a learning model.

8. The wireless device of claim 1, wherein the one or more processors are individually or collectively further operable to execute the code to cause the wireless device to:
process, based at least in part on the configuration and an availability of one or more resources in a grant associated with the second radio link control entity, the set of protocol data units, by one or more of splitting or routing the one or more protocol data units of the set of protocol data units to one or more of the first radio link control entity or the second radio link control entity of the wireless device irrespective of the uplink data volume threshold and the uplink data volume associated with the second radio link control entity.

9. The wireless device of claim 1, wherein the one or more processors are individually or collectively further operable to execute the code to cause the wireless device to:
determine whether to disable the first radio link control entity or the second radio link control entity of the wireless device for a duration according to a learning model associated with the packet data convergence protocol entity of the wireless device, wherein an input to the learning model comprises one or more of the first set of one or more parameters or the second set of one or more parameters; and
disable the first radio link control entity or the second radio link control entity of the wireless device for the duration based at least in part on the determination, wherein an output of the learning model indicates to disable the first radio link control entity or the second radio link control entity of the wireless device.

10. The wireless device of claim 9, wherein the one or more processors are individually or collectively further operable to execute the code to cause the wireless device to:
perform a protocol data unit recovery procedure by routing at least one protocol data unit of the set of protocol data units from the first radio link control entity to the second radio link control entity of the wireless device based at least in part on disabling the first radio link control entity of the wireless device.

11. The wireless device of claim 1, wherein the one or more processors are individually or collectively further operable to execute the code to cause the wireless device to:
switch from the first radio link control entity as a primary radio link control path to the second radio link control entity as the primary radio link control path for the set of protocol data units; or
switch from the second radio link control entity as the primary radio link control path to the first radio link control entity as the primary radio link control path for the set of protocol data units.

12. The wireless device of claim 1, wherein a third set of one or more parameters comprise an output of a learning model associated with the packet data convergence protocol entity of the wireless device, and wherein the third set of one or more parameters is based at least in part on a first channel quality indicator threshold value associated with the first radio link control entity of the wireless device, a second channel quality indicator threshold value associated with the second radio link control entity of the wireless device, or both.

13. The wireless device of claim 1, wherein the one or more processors are individually or collectively further operable to execute the code to cause the wireless device to:
store a set of one or more logs associated with a learning model, wherein at least one first log of the set of one or more logs comprises a set of previous selected values of the plurality of values for the at least one parameter, wherein at least one second log of the set of one or more logs comprises a third set of one or more parameters associated with one or more of the first radio link control entity or the second radio link control entity of the wireless device, the third set of one or more parameters comprising one or more of a channel quality indicator or a reference signal received power, wherein at least one third log of the set of one or more logs comprises a fourth set of one or more parameters associated one or more of the first radio link control entity or the second radio link control entity of the wireless device, the fourth set of one or more parameters comprising one or more of a channel quality indicator threshold value or a reference signal received power threshold value, wherein at least one fourth log of the set of one or more logs comprises a fifth set of one or more parameters comprising at least one parameter that indicates an end-to-end (E2E) delay associated with one or more of the first radio link control entity or the second radio link control entity of the wireless device, and wherein at least one fifth log of the set of one or more logs comprises an indication of one or more recovery procedures performed by the wireless device and associated with one or more of the first radio link control entity or the second radio link control entity of the wireless device; and
transmit, to a second wireless device, a report comprising the set of one or more logs associated with the learning model.

14. The wireless device of claim 1, wherein the one or more processors are individually or collectively further operable to execute the code to cause the wireless device to:
transmit, to a second wireless device, a report comprising capability information that indicates whether the wireless device supports a learning model associated with one or more of splitting or routing the set of protocol data units, wherein the capability information further indicates whether the wireless device supports one or more of predicting latency associated with one or more of the first radio link control entity or the second radio link control entity of the wireless device, or reporting of an accuracy of the learning model,
wherein the control signaling is received based at least in part on the capability information.

15. The wireless device of claim 1, wherein the first set of one or more parameters comprises one or more of at least one first parameter that indicates a first threshold value for the uplink data volume, at least one second parameter that indicates a second threshold value for the uplink data volume, at least one third parameter that indicates a threshold quantity of grants allowed to be missed at the wireless device for the first radio link control entity, at least one fourth parameter that indicates whether the wireless device is configured to disable at least one of the first radio link control entity or the second radio link control entity, at least one fifth parameter that indicates whether data recovery is configured in response to at least one of the first radio link control entity or the second radio link control entity being disabled, at least one sixth parameter that indicates a first threshold duration for disabling at least one of the first radio link control entity or the second radio link control entity, at least one seventh parameter that indicates a second threshold duration to be satisfied prior to disabling at least one of the first radio link control entity or the second radio link control entity, at least one eighth parameter that indicates whether primary path switching is allowed for at least one of the first radio link control entity or the second radio link control entity of, at least one nineth parameter that indicates a channel quality indicator value to be satisfied prior to disabling at least one of the first radio link control entity or the second radio link control entity of the wireless device, at least one tenth parameter that indicates whether a learning model is enabled or disabled, or at least one eleventh parameter that indicates whether the learning model is enabled or disabled for a Quality-of-Service (QOS) flow associated with the set of protocol data units.

16. The wireless device of claim 1, wherein the second set of one or more parameters comprises one or more of at least one first parameter that indicates a first criterion associated with an order of transmission or reception of the set of protocol data units, at least one second parameter that indicates a second criterion associated with retransmission of the one or more protocol data units of the set of protocol data units, at least one third parameter that indicates a third criterion associated with a latency of transmission, reception, or retransmission of the one or more protocol data units of the set of protocol data units, or at least one fourth parameter that indicates a fourth criterion associated with a reordering window for the one or more protocol data units of the set of protocol data units.

17. The wireless device of claim 1, wherein the one or more processors are individually or collectively further operable to execute the code to cause the wireless device to:
receive, from a second wireless device, a report that indicates a performance associated with one or more of the first set of one or more parameters or the second set of one or more parameters for one or more of splitting or routing the set of protocol data units by the packet data convergence protocol entity of the wireless device to one or more of the first radio link control entity or the second radio link control entity of the wireless device.

18. A method for wireless communications at a wireless device, comprising:
receiving control signaling that indicates a configuration comprising a first set of one or more parameters for one or more of splitting or routing a set of protocol data units by a packet data convergence protocol entity of the wireless device to one or more of a first radio link control entity or a second radio link control entity of the wireless device, wherein at least one parameter of the first set of one or more parameters is associated with a plurality of values, a plurality of performance metrics, or a combination thereof;
selecting a value of the plurality of values for the at least one parameter, for one or more of splitting or routing the set of protocol data units, based at least in part on a second set of one or more parameters, wherein the selected value corresponds to an uplink data volume threshold; and
processing the set of protocol data units, by one or more of splitting or routing one or more protocol data units of the set of protocol data units to one or more of the first radio link control entity or the second radio link control entity of the wireless device, based at least in part on an uplink data volume associated with one or more of the packet data convergence protocol entity, the first radio link control entity, or the second radio link control entity and according to the selected value.

19. The method of claim 18, further comprising:
obtaining the value from a learning model associated with the packet data convergence protocol entity of the wireless device, wherein an input to the learning model comprises one or more of the first set of one or more parameters or the second set of one or more parameters, wherein the value comprises an output of the learning model,
wherein the value is selected based at least in part on the output of the learning model.

20. A non-transitory computer-readable medium storing code for wireless communications at a wireless device, the code comprising instructions executable by one or more processors to:
receive control signaling that indicates a configuration comprising a first set of one or more parameters for one or more of splitting or routing a set of protocol data units by a packet data convergence protocol entity of the wireless device to one or more of a first radio link control entity or a second radio link control entity of the wireless device, wherein at least one parameter of the first set of one or more parameters is associated with a plurality of values, a plurality of performance metrics, or a combination thereof;
select a value of the plurality of values for the at least one parameter, for one or more of splitting or routing the set of protocol data units, based at least in part on a second set of one or more parameters, wherein the selected value corresponds to an uplink data volume threshold; and
process the set of protocol data units, by one or more of splitting or routing one or more protocol data units of the set of protocol data units to one or more of the first radio link control entity or the second radio link control entity of the wireless device, based at least in part on an uplink data volume associated with one or more of the packet data convergence protocol entity, the first radio link control entity, or the second radio link control entity and according to the selected value.
